(19) United States
(12) Patent Application Publication
(10) Pub. No.: US 2024/0305205 A1
(43) Pub. Date: Sep. 12, 2024

(54) POWER SUPPLY CONTROL DEVICE

(71) Applicant: Rohm Co., Ltd., Kyoto (JP)

(72) Inventor: Natsuki Yamamoto, Kyoto (JP)

(21) Appl. No.: 18/597,407

(22) Filed: Mar. 6, 2024

(30) Foreign Application Priority Data
Mar. 10, 2023 (JP) 2023-037440

(51) Int. Cl. H02M 3/335; H02M 1/08

(52) U.S. Cl. CPC H02M 3/33523; H02M 1/08

(57) ABSTRACT

The present disclosure provides a power supply control device used in an insulated DC/DC converter that uses a transformer to generate a secondary side output voltage from a primary side input voltage. The power supply control device includes a switching element and a switching control circuit. The switching element is connected in series to a primary winding of the transformer. The switching control circuit is configured to drive the switching element. The power supply control device is configured to be capable of adding jitter to a switching frequency. An application of jitter is stopped when the switching control circuit performs switching drive in a current discontinuous mode.

### TECHNICAL FIELD

The present disclosure relates to a power supply control device.

### BACKGROUND

An insulated direct-current/direct-current (DC/DC) converter that uses a transformer to generate an output voltage on a secondary side from an input voltage in a primary side is extensively applied. In the insulated DC/DC converter, a mode of switch driving switching transistors by disposing the switching transistors on a primary winding set of a transformer is often adopted. Devices that handle switch driving of switching transistors have been developed.

### PRIOR ART DOCUMENT

### Patent Publication

[Patent document 1] Japan Patent Publication No. 2020-61819

### BRIEF DESCRIPTION OF THE DRAWINGS

FIG. 1 is a diagram of a brief overall configuration of a load drive system according to an embodiment of the present disclosure.

FIG. 2 is a perspective diagram of the appearance of a power supply control device according to an embodiment of the present disclosure.

FIG. 3 is a diagram of an overall configuration of a load drive system including an internal block diagram of a DC/DC converter related to an embodiment of the present disclosure.

FIG. 4 is a timing diagram of a DC/DC converter related to an embodiment of the present disclosure.

FIG. 5 is a waveform diagram of a primary current and a secondary current in a current continuous mode related to an embodiment of the present disclosure.

FIG. 6 is a waveform diagram of a primary current and a secondary current in a discontinuous current mode related to an embodiment of the present disclosure.

FIG. 7 is a diagram of a relationship between an output power and a switching frequency related to an embodiment of the present disclosure (wherein it is assumed that no jitter is added to the switching frequency).

FIG. 8 is a timing diagram of a response to a change in an output power related to an embodiment of the present disclosure.

FIG. 9 is a diagram of an internal circuit and peripheral circuits of a current source 121 in FIG. 3.

FIG. 10 is a diagram of a method of adding a jitter to a switching frequency related to an embodiment of the present disclosure.

FIG. 11 is a diagram of a relationship between an output frequency and a switching frequency when a jitter is constantly added to a switching frequency related to an embodiment of the present disclosure.

FIG. 12 is a configuration diagram of a jitter control circuit related to a first embodiment of embodiments of the present disclosure.

FIG. 13 is a diagram of waveforms of several signals in a discontinuous current mode (DCM) related to the first embodiment of embodiments of the present disclosure.

FIG. 14 is a diagram of waveforms of several signals in a continuous current mode (CCM) related to the first embodiment of embodiments of the present disclosure.

FIG. 15 is a configuration diagram of a jitter control circuit and peripheral circuits thereof related to a second embodiment of embodiments of the present disclosure.

FIG. 16 is a diagram of waveforms of several signals in a DCM related to the second embodiment of embodiments of the present disclosure.

FIG. 17 is a configuration diagram of a jitter control circuit and peripheral circuits thereof related to a third embodiment of embodiments of the present disclosure.

FIG. 18 is a diagram of waveforms of several signals in a DCM related to the third embodiment of embodiments of the present disclosure.

FIG. 19 is a diagram of waveforms of several signals in a CCM related to the third embodiment of embodiments of the present disclosure.

FIG. 20 is a configuration diagram of a jitter control circuit and peripheral circuits thereof related to a fourth embodiment of embodiments of the present disclosure.

FIG. 21 is a diagram of waveforms of several signals in a DCM related to the fourth embodiment of embodiments of the present disclosure.

FIG. 22 is a diagram of waveforms of several signals in a CCM related to the fourth embodiment of embodiments of the present disclosure.

FIG. 23 is a diagram of waveforms of several signals in a CCM related to the fourth embodiment of embodiments of the present disclosure.

FIG. 24 is a configuration diagram of a jitter control circuit and peripheral circuits thereof related to a fifth embodiment of embodiments of the present disclosure.

FIG. 25 is a diagram of a method of variably setting an amount of a jitter related to the fifth embodiment of embodiments of the present disclosure.

FIG. 26 is a diagram of a method of variably setting an amount of a jitter related to the fifth embodiment of embodiments of the present disclosure.

### DETAILED DESCRIPTION OF THE EMBODIMENTS

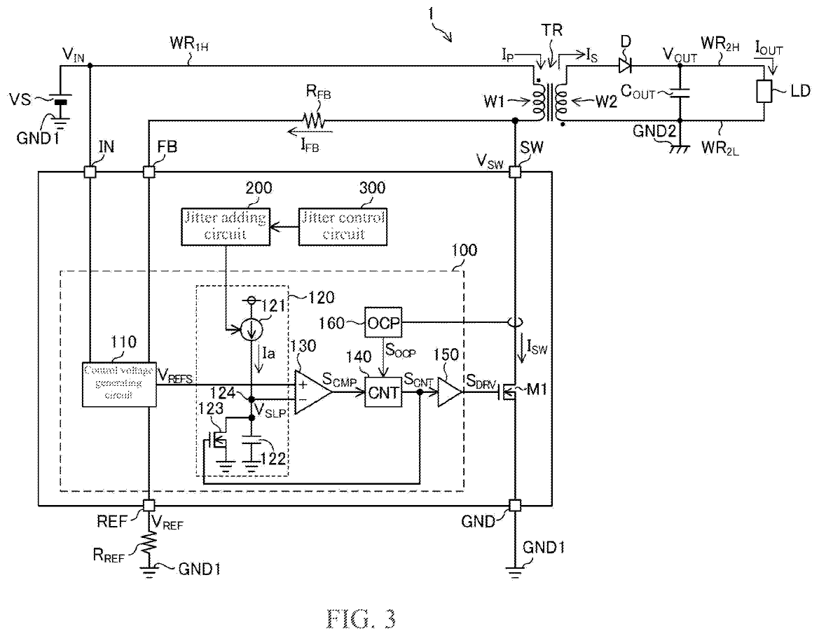

Details of the embodiments of the present disclosure are given with the accompanying drawings below. In the reference drawings, the same parts are denoted by the same numerals or symbols, and repeated description related to the same parts is in principle omitted. Moreover, in the present application, in order to keep the description simple, by means of recording numerals or symbols of reference information, signals, physical quantities, functional units, circuits, elements or parts, names of information, signals, physical quantities, functional units, circuits, elements or parts corresponding to the numerals or symbols are sometimes omitted or abbreviated. For example, a control voltage generating circuit 110 (referring to FIG. 3) reference by “110” is sometimes expressed as a control voltage generating circuit 110, and is sometimes abbreviated as a circuit 110; however, both of them refer to the same component.

Some terms used in the description of the embodiments of the disclosure are first explained below. For any concerned signal or voltage, the level refers to the level of a potential, and a high level has a potential higher than that of a low potential. For any concerned signal or voltage, switching from a low level to a high level is referred to as a rising edge, and switching from a low level to a high level is referred to as a rising edge. The rising edge can also be alternatively referred to as a positive edge. The falling edge can also be alternatively referred to as a negative edge.

For any transistor configured as a field-effect transistor (FET) including a metal-oxide-semiconductor field-effect transistor (MOSFET), an on state refers to a state of conduction between the drain and the source of the transistor, and an off state refers to a state of non-conduction (a state of disconnection) between the drain and the source of the transistor. The same applies to those categorized as non-FET transistors. Unless otherwise specified, a MOSFET is to be understood as an enhanced MOSFET. The term MOSFET is an abbreviation of metal-oxide-semiconductor field-effect transistor. Moreover, unless otherwise specified, in any MOSFET, it is considered that the back gate is shorted with the source.

In the description below, for any transistor, the on state and the off state may also be expressed simply as on and off. For any transistor, switching from an off state to an on state is expressed as turning on, and switching from an on state to an off state is expressed as turning off. Moreover, for any transistor, a period in which the transistor becomes in an on state is referred to an on-period, and a period in which the transistor becomes in an off state is referred to as an off-period.

For any signal of which the signal level is a high level or a low level, a period in which the level of the signal becomes a high level is referred to as a high level period, and a period in which the level of the signal becomes a low level is referred to as a low level period. The same applies to any voltage of which the voltage level is a high level or a low level.

Unless otherwise specified, a connection formed between multiple parts of a circuit, such as elements, wires and nodes that form a circuit, is to be understood as an electrical connection.

When any two voltages to be compared are set to be a voltage v1 and a voltage v2, “v1>v2” means that the voltage v1 is higher than the voltage v2, and “v1<v2” means that the voltage v1 is lower than the voltage v2. The same applies to other equations including physical quantities other than voltages.

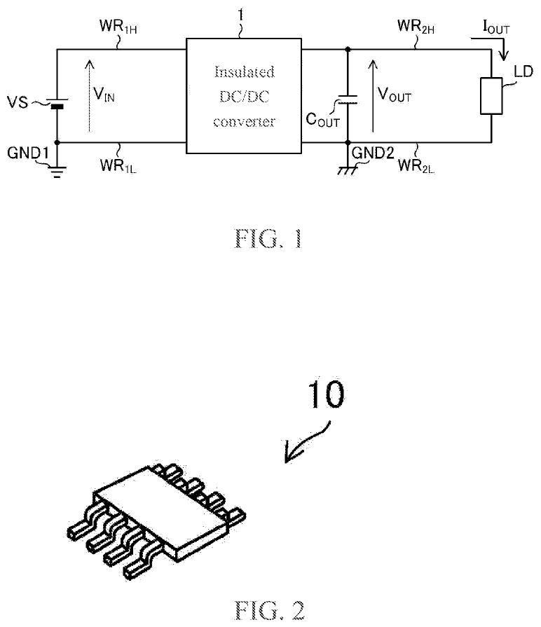

FIG. 1 shows a diagram of a brief overall configuration of a load drive system according to an embodiment of the present disclosure. The load drive system in FIG. 1 includes a voltage source VS, a DC/DC converter 1 used as an insulated DC/DC converter, an output capacitor C_{OUT}, and a load LD. It can also be understood that the output capacitor C_{OUT} is included in constituent elements of the DC/DC converter 1.

The load drive system in FIG. 1 includes a primary circuit and a secondary circuit. The primary circuit and the secondary circuit are electrically insulated from each other. In the present application, the term “insulated” means that transmissions of DC signals and electrical power are disconnected. The voltage source VS is disposed in the primary circuit, and the output capacitor C_{OUT} and the load LD are disposed in the secondary circuit. The DC/DC converter 1 is disposed across the primary circuit and the secondary circuit.

Ground in the primary circuit is referenced by “GND1”, and ground in the secondary circuit is referenced by “GND2”. Any voltage or signal in the primary circuit is a voltage or signal regarding the ground GND1 as a reference, and has a potential viewed from the ground GND1. Any voltage or signal in the secondary circuit is a voltage or signal regarding the ground GND2 as a reference, and has a potential viewed from the ground GND2. In each of the primary circuit and the secondary circuit, the ground refers to a reference conductive portion (a predetermined potential point) having a reference potential of 0 V or the reference potential itself. However, since the ground GND1 and the ground GND2 are insulated from each other, they may have different potentials from each other. The reference conductive portion is a conductor formed of such as metal. Wirings WR_{1L} and WR₁H are disposed in the primary circuit, and wirings WR_{2L} and WR₂H are disposed in the secondary circuit.

The voltage source VS is connected to between the wirings WR_{1L} and WR₁H, and outputs the input voltage V_{IN} to the wiring WR₁H by regarding a potential of the wiring WR_{1L} as a reference. The wiring WR_{1L} is connected to the ground GND1. The input voltage V_{IN} is in principle a positive DC voltage. Thus, a potential that is higher a potential of the ground GND1 by the input voltage V_{IN} is applied to the wiring WR₁H. The voltage source VS can also be a DC voltage source such as a battery cell. Alternatively, the voltage source VS can also be formed by a circuit that rectifies and smooths an AC voltage.

The DC/DC converter 1 is connected to the wirings WR_{1L} and WR_{1H} on the primary side, and is connected to the wirings WR_{2L} and WR₂H on the secondary side. The DC/DC converter 1 performs power conversion (DC-to-DC conversion) on the input voltage V_{IN} by means of switching to generate an output voltage V_{OUT}. The input voltage V_{IN} is a voltage in the primary circuit, and the output voltage V_{OUT} is a voltage in the secondary circuit. Thus, the input voltage V_{IN} can be referred to as a primary voltage, and the output voltage V_{OUT} can be referred to as a secondary voltage. The DC/DC converter 1 outputs the output voltage V_{OUT} to the wiring WR₂H by regarding the potential of the wiring WR_{2L} as a reference. The wiring WR_{2L} is connected to the ground GND2. Thus, a potential that is higher than a potential of the ground GND2 by the output voltage V_{OUT} is applied to the wiring WR₂H. Except for in a transient state, the output voltage V_{OUT} is a positive DC voltage. One end of the output capacitor C_{OUT} is connected to the wiring WR_{2L} (hence connected to the ground GND2), and the other end of the output capacitor C_{OUT} is connected to the wiring WR_{2H}.

The load LD is a load of the DC/DC converter 1, and is connected to the wirings WR_{2L} and WR_{2R}. The load LD is any load that receives the output voltage V_{OUT} and is driven based on the output voltage V_{OUT}. For example, the load LD includes a microcomputer, a digital signal processor (DSP), a lighting device, an analog circuit or a digital circuit. The load LD can include a power supply circuit different from the DC/DC converter 1. A current supplied from the DC/DC converter 1 to the load LD is referred to as an output current I_{OUT}. The output current I_{OUT} is a consumption current of the load LD, and flows from the wiring WR₂H through the load LD to the wiring WR_{2L}.

FIG. 2 shows a perspective diagram of an appearance of a power supply control device 10 disposed in the DC/DC converter 1. FIG. 3 shows a diagram of an overall configuration of a load overpass system including an internal block diagram of the DC/DC converter 1. The power supply control device 10 is an electronic component including the following parts: a semiconductor chip, having a semiconductor integrated circuit formed on a semiconductor substrate; a housing (a package), accommodating the semiconductor chip; and a plurality of external terminals, exposed on the outside the power supply control device 10 from the housing. The power supply control device 10 is formed by packaging the semiconductor chip in the housing (package) formed of a resin. Moreover, the number of external terminals of the power supply control device 10 and the type of the housing of the power supply control device 10 shown in FIG. 2 are merely examples, and can be designed as desired. FIG. 3 depicts a power supply input terminal IN, a switching terminal SW and a ground terminal GND, and output voltage setting terminals FB and REF provided as a part of external terminals in the power supply control device 10. External terminals other than those terminals above can also be provided in the power supply control device 10.

In the DC/DC converter 1, in addition to the power supply control device 10, resistors R_{FB} and R_{REF}, a transformer TR and a rectifier diode D are also provided. As described above, it can be understood that the output capacitor C_{OUT} is included in constituent elements of the DC/DC converter 1. The transformer TR includes a primary winding W1 and a secondary winding W2. The primary winding W1, the power supply control device 10, the resistors R_{FB} and R_{REF} and the voltage source VS are together provided in the primary circuit. The secondary winding W2, the rectifier diode D, the output capacitor C_{OUT} and the load LD are together provided in the secondary circuit.

First of all, the external configuration of the power supply control device 10 in the configuration in FIG. 3, an exterior of the power supply control device 10 and a connection relationship of the power supply control device 10 are described below.

The power supply input terminal IN is connected to the wiring WR₁H and receives the input voltage V_{IN}. The ground terminal GND is connected to the ground GND1. The circuits in the power supply control device 10 are driven based on the input voltage V_{IN} by regarding the potential of the ground GND1 as a reference. A first end of the resistor R_{REF} is connected to the output voltage setting terminal REF, and a second end of the resistor R_{REF} is connected to the ground GND1. Moreover, a voltage at the output voltage setting terminal REF is referred to as a terminal voltage V_{REF}.

In the transformer TR, the primary winding W1 and the secondary winding W2 are electrically insulated from each other and are magnetically coupled to each other with opposite polarities. A first end of the primary winding W1 is connected to the wiring WR₁H and receives the input voltage V_{IN}. A second end of the primary winding W1 is connected to the switching terminal SW, and is connected to a first end of the resistor R_{FB}. A second end of the resistor R_{FB} is connected to the output voltage setting terminal FB. A current flowing from the first end of the primary winding W1 to the second end of the primary winding W1 is referred to as a primary current, and is referenced by a denotation “I_{P}”. During an on-period of the switching transistor M1 to be described below, the primary current I_{P} flows from the voltage source VS through the wiring WR₁H, the primary winding W1 and the switching transistor M1 to the ground GND1. Moreover, the denotation “I_{FB}” is used to reference a current flowing from the second end of the primary winding W1 through the resistor R_{FB} to the terminal FB. In addition, a voltage in the switching terminal SW is referred to as a switch voltage, and is referenced by a denotation “V_{SW}”.

A first end of the secondary winding W2 is connected to an anode of the rectifier diode D. A second end of the secondary winding W2 is connected to the wiring WR_{2L} (hence connected to the ground GND2). A cathode of the rectifier diode D is connected to the wiring WR_{2H}. As described above, the output capacitor C_{OUT} is connected between the wirings WR_{2H} and WR_{2L}. A current flowing from the second end of the secondary winding W2 to the first end of the secondary winding W2 is referred to as a secondary current, and is referenced by a denotation “I_{S}”. The secondary current I_{S} flows in a positive direction of the rectifier diode D, passes through the rectifier diode D and is for charging the output capacitor C_{OUT}.

The internal configuration of the power supply control device 10 is described below. In the power supply control device 10, the switching transistor M1, a switching control circuit 100, a jitter adding circuit 200 and a jitter control circuit 300 are provided. Various function circuits (an internal power supply circuit, a short-circuitry protection circuit, and a low voltage protection circuit) apart from the circuits above are provided in the power supply control device 10, and the configuration in FIG. 3 is described in detail below.

The switching transistor M1 is a switching element including an N-channel MOSFET. A drain of the switching transistor M1 is connected to the switching terminal SW. A source of the switching transistor M1 is connected to the ground terminal GND, hence connected to the GND1. A current flowing through a channel of the switching transistor M1 (that is, a drain current of the switching transistor M1) is referred to as a switch current, and is reference by a denotation “I_{SW}”. During an on-period of the switching transistor M1, the primary current I_{P} is a sum of the currents I_{SW} and I_{FB}, and since it can be regarded that “I_{SW}>>I_{FB}”, it can be appropriately considered that the primary current I_{P} is equal to the switch current I_{SW} in the description below. Moreover, a variation in which the switching transistor M1 is provided outside the power supply control device 10 can also be implemented.

The switching control circuit 100 is connected to the terminals IN, FB and REF, and switch drives the switching transistor M1 based on the voltages of the terminals IN, FB and REF. The switch driving of the switching transistor M1 refers to controlling the switching transistor M1 to be alternately on and off. The switching control circuit 100 transmits electrical power from the primary circuit to the secondary circuit by switch driving the switching transistor M1, and accordingly the secondary circuit generates the output voltage V_{OUT} based on the input voltage V_{IN}. However, more specifically, the transmission of the electrical power is implemented also by collaboration of other constituting elements (constituting elements other than the power supply control device 10, including the transformer TR and the rectifier diode D) provided in the DC/DC converter 1.

With the primary current I_{P} flowing during the on-period of the switching transistor M1, energy is accumulated in the primary winding W1. Then, the accumulated energy is released from the secondary winding W2 during an off-period of the switching transistor M1 (more specifically, the secondary current I_{S} based on the accumulated energy flows through the rectifier diode D during an off-period of the switching transistor M1), accordingly charging the output capacitor C_{OUT}. By repeatedly switching on and off the switching transistor M1, the required output voltage V_{OUT} can be obtained.

The switching control circuit 100 includes a control voltage generating circuit 110, a slope voltage generating circuit 120, a comparator 130, a control logic 140, a driver 150, and an overcurrent protection circuit 160.

The control voltage generating circuit 110 is connected to the terminals IN, FB and REF, and generates a control voltage V_{REF}s based on the voltages of the terminals IN, FB and REF. Details of a method for generating the control voltage V_{REFS} are to be described below.

The slope voltage generating circuit 120 includes a current source 121, a capacitor 122 and a transistor 123, and generates a slope voltage V_{SLP} as a voltage having a triangular waveform. The transistor 123 can be any type of transistor as desired, and is implemented by an N-channel MOSFET herein. The current source 121 supplies a current Ia from a terminal applied with a positive internal power supply voltage to a node 124. The current Ia is fundamentally a constant current; however, the value of the current Ta changes in accordance with the jitter adding circuit 200. The node 124 is connected to one end of the capacitor 122 and a drain of the transistor 123. The other end of the transistor 122 and a source of the transistor 123 are grounded. A voltage at the node 124 is referred to as the slope voltage V_{SLP}.

The control voltage V_{REFS} is input to a non-inverting input terminal of the comparator 130, and the slope voltage V_{SLP} is input to an inverting input terminal of the comparator 130. The comparator 130 compares the control voltage V_{REFS} with the slope voltage V_{SLP}, and generates and outputs a comparison result signal S_{CMP} indicating a comparison result thereof. The signal S_{CMP} and signals S_{CNT}, S_{DRV} and S_{OCP} described below have a signal level of a high level or a low level. The comparator 130 generates and outputs the comparison result signal S_{CMP} having a high level when “V_{REFS}>V_{SLP}” holds true, and generates and outputs the comparison result signal S_{CMP} having a low level when “V_{REFS}<V_{SLP}” holds true. When V_{REFS}=V_{SLP}” holds true, the comparison result signal S_{CMP} has a high level or a low level.

The comparison result signal S_{CMP} from the comparator 130 is input to the control logic 140. The control logic 140 generates the control signal S_{CNT} based on the comparison result signal S_{CMP}. Moreover, the overcurrent protection signal S_{OCP} from the overcurrent protection circuit 160 is also input to the control logic 140. A relationship between the comparison result signal S_{CMP} and the control signal S_{CNT}, and a relationship between the overcurrent protection signal S_{OCP} and the control signal S_{CNT} are to be described below. The control signal S_{CNT} is supplied to the driver 150, and is also supplied to a gate of the transistor 123. The transistor 123 is controlled to be on during a high level period of the control signal S_{CNT}, and is controlled to be off during a low level period of the control signal S_{CNT}. During an on-period of the transistor 123, the node 124 and the ground GND1 are shorted via the transistor 123, and so the slope voltage V_{SLP} is 0 V. During an off-period of the transistor 123, the capacitor 122 is charged by the current Ia and hence the slope voltage V_{SLP} monolithically increases.

The driver 150 is connected to the gate of the switching transistor M1, and supplies the driving signal S_{DRV} corresponding to the control signal S_{CNT} from the control logic 140 to the gate of the switching transistor M1. A potential of the driving signal S_{DRV} at a high level is sufficiently higher than a gate threshold voltage of the switching transistor M1. A potential of the driving signal S_{DRV} at a low level is substantially consistent with the potential of the ground GND1, and is sufficiently lower than the gate threshold voltage of the switching transistor M1. During a high level period of the control signal S_{CNT}, the driver 150 controls the switching transistor M1 to be on by supplying the driving signal S_{DRV} at a high level to the gate of the switching transistor M1; during a low level period of the control signal S_{CNT}, the driver 150 controls the switching transistor M1 to be off by supplying the driving signal S_{DRV} at a low level to the gate of the switching transistor M1.

The overcurrent protection circuit 160 detects a magnitude relationship between the switch current I_{SW} and a predetermined protection current I_{OCP}, and generates and outputs the overcurrent protection signal S_{OCP} indicating a detection result thereof. The overcurrent protection circuit 160 generates and outputs the overcurrent protection signal S_{OCP} at a high level when “I_{SW}>I_{OCP}” holds true, and generates and outputs the overcurrent protection signal S_{OCP} at a low level when “I_{SW}<I_{OCP}” holds true. When “I_{SW}=I_{OCP}” holds true, the overcurrent protection signal S_{OCP} has a high level or a low level. In this embodiment, unless otherwise specified, it is considered that the overcurrent protection signal S_{OCP} is kept at a low level.

A denotation “f_{SW}” is used to reference a switching frequency of the switching transistor M1. The jitter adding circuit 200 has a function of adding a jitter to the switching frequency f_{SW} of the switching transistor M1. Details associated with the jitter adding circuit 200 and the jitter control circuit 300 are described below. First of all, details of switching control performed by the switching control circuit 100 are given by assuming that no jitter is added to the switching frequency f_{SW}.

When the switching transistor M1 is off, the switch voltage V_{SW} is higher than the input voltage V_{IN} by a flyback voltage of the primary side. That is to say, if V_{SW}[OFF] is used to represent the switch voltage V_{SW} during the off-period of the switching transistor M1, equation (1) below holds true. Herein, N_{P} represents the number of turns of the primary winding W1 and N_{S} represents the number of turns of the secondary winding W2. V_{F} represents a forward voltage of the rectifier diode D. The flyback voltage Vor of the primary side during the off-period of the switching transistor M1 is Vor=(N_{P}/N_{S})×(V_{OUT}+V_{F}).

$$Equation ( 1 )$$

$${V}_{SW} [ OFF ] = {V}_{IN} + \frac{{N}_{P}}{{N}_{S}} \times ( {V}_{OUT} + {V}_{F} ) \qquad ( 1 )$$

On the other hand, the control voltage generating circuit 110 operates by applying a voltage having a voltage value equal to that of the input voltage V_{IN} to the terminal FB. Thus, the current I_{FB} satisfies equation (2) below. Moreover, in equations shown below, “R_{FB}” represents a value of the resistor R_{FB}, and “R_{REF}” represents a value of the resistor R_{REF}. In addition, the control voltage generating circuit 110 supplies the current I_{FB} (the current I_{FB} satisfying equation (2)) flowing into the terminal FB to the resistor R_{REF}. Thus, a terminal voltage V_{REF} generated at the terminal REF satisfies equation (3) below.

$$Equation ( 2 )$$

$${I}_{FB} = \frac{{V}_{SW} - {V}_{IN}}{{R}_{FB}} \qquad ( 2 )$$

$${V}_{REF} = {I}_{FB} \times {R}_{REF} \qquad ( 3 )$$

By modifying equation (3) with equations (1) and (2), equation (4) is obtained. However, equation (4) is only a calculation formula that holds true during the off-period of the switching transistor M1, and the terminal voltage V_{REF} is substantially 0 V during the on-period of the switching transistor M1.

$$Equation ( 3 )$$

$${V}_{REF} = \frac{{R}_{REF}}{{R}_{FB}} \times \frac{{N}_{P}}{{N}_{S}} \times ( {V}_{OUT} + {V}_{F} ) \qquad ( 4 )$$

It is known from equation (4) that, the terminal voltage V_{REF} during the off-period of the transistor M1 includes information of the output voltage V_{OUT}. Thus, if the transistor M1 is driven based on the terminal voltage V_{REF}, the output voltage V_{OUT} can be stabilized at a required voltage. The control voltage generating circuit 110 generates the control voltage V_{REFS} by sampling the terminal voltage V_{REF} during the off-period of the switching transistor M1. Thus, it can considered that the control voltage V_{REFS} has a value of the terminal voltage V_{REF} during the off-period of the switching transistor M1.

The DC/DC converter 1 is fundamentally designed to drive the switching transistor M1 by a current continuous mode. The switching control circuit 100 is capable of performing feedback control to have the control voltage V_{REFS} be consistent with a predetermined internal setting voltage V_{INTREF} in the current continuous mode. On the other hand, the terminal voltage V_{REF} in equation (4) can be regarded as the control voltage V_{REFS}, and thus the output voltage V_{OUT} can stabilized so as to satisfy equation (5) below by the feedback control. A voltage shown on the right side of equation (5) is referred to as a target voltage V_{TG}. That is to say, the target voltage V_{TG} is represented by equation (6). The internal setting voltage V_{INTREF} has a positive DC voltage value (for example, several hundreds mV).

$$Equation ( 4 )$$

$${V}_{OUT} = \frac{{R}_{FB}}{{R}_{REF}} \times \frac{{N}_{S}}{{N}_{P}} \times {V}_{INTREF} - {V}_{F} \qquad ( 5 )$$

$${V}_{TG} = \frac{{R}_{FB}}{{R}_{REF}} \times \frac{{N}_{S}}{{N}_{P}} \times {V}_{INTREF} - {V}_{F} \qquad ( 6 )$$

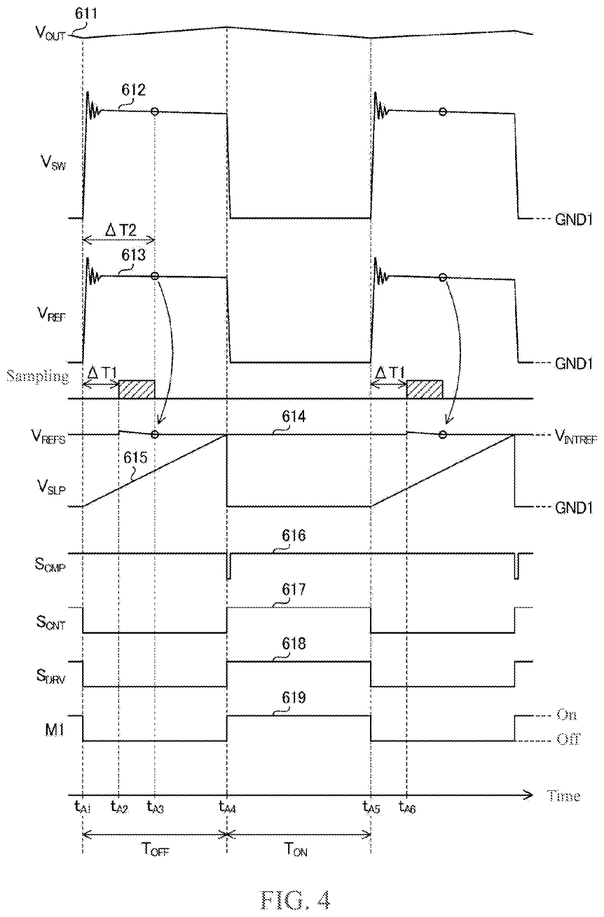

FIG. 4 shows a timing diagram of the DC/DC converter 1. In FIG. 4, the following condition is assumed, that is, the switching transistor M1 is switch driven in the current continuous mode, and the output voltage V_{OUT} is stabilized around the target voltage V_{TG}. In FIG. 4, waveforms 611 to 615 are respectively waveforms of the output voltage V_{OUT}, the switch voltage V_{SW}, the terminal voltage V_{REF}, the control voltage V_{REFS} and the slope voltage V_{SLP}. In FIG. 4, waveforms 616 to 618 are respectively waveforms of the signals S_{CMP}, S_{CNT} and S_{DRV}. In FIG. 4, a waveform 619 represents a waveform of a state of the switching transistor M1.

Referring to FIG. 4, an operation of the DC/DC converter 1 is described below by regarding a timing before a timing t_{A1} as a starting point. As the time progresses, timings t_{A1}, t_{A2}, t_{A3}, t_{A4}, t_{A5} and t_{A6} sequentially arrive. Moreover, to simplify the description herein, a delay between a signal level change of the control signal S_{CNT} and a change in the state of the switching transistor M1 is omitted. In addition, a period for switching the switching transistor M1 is referred to as a switching cycle. A length of the switching cycle is equal to a reciprocal of the switching frequency f_{SW} of the switching transistor M1.

Closely before the timing t_{A1}, the control signal S_{CNT} has a high level, and thus the switching transistor M1 is in an on state and the switch voltage V_{SW} is substantially 0 V (substantially equal to the potential of the ground GND1). During a high level period of the control signal S_{CNT}, the transistor 123 is in an on state (referring to FIG. 3). Thus, closely before the timing t_{A1}, the slope voltage V_{SLP} is 0 V (that is to say, equal to the potential of the ground GND1).

At the timing t_{A1}, a falling edge is generated in the control signal S_{CNT}, and a falling edge is generated in the driving signal S_{DRV} in response to the falling edge of the control signal S_{CNT}. Thus, the switching transistor M1 is turned off at the timing t_{A1}. As the switching transistor M1 is turned off, the switch voltage V_{SW} increases drastically and becomes a voltage that satisfies equation (1) above due to ringing. As described above, the control voltage generating circuit 110 supplies the current I_{FB} (the current I_{FB} satisfying equation (2)) flowing into the terminal FB to the resistor R_{REF}. Therefore, the waveform of the terminal voltage V_{REF} has a similar relationship as the waveform of the switch voltage V_{SW}.

The control voltage generating circuit 110 has a function of sampling and holding the terminal voltage V_{REF}. After the switching transistor M1 is turned off and before a predetermined time ΔT1 has elapsed, the circuit 110 holds the control voltage V_{REFS} at the terminal voltage V_{REF} held last time. This is to eliminate influences of ringing in the switch voltage V_{SW} caused as the switching transistor M1 is turned off. When the predetermined time ΔT1 has elapsed after the switching transistor M1 is turned off, the circuit 110 starts sampling the terminal voltage V_{REF}, and sets the sampled terminal voltage V_{REF} as the control voltage V_{REFS}. At a timing when a predetermined time ΔT2 has elapsed after the switching transistor M1 is turned off, the circuit 110 stops sampling the terminal voltage V_{REF}, and holds the terminal voltage V_{REF} of this timing. Then, the circuit 110 sets the held terminal voltage V_{REF} to be the control voltage V_{REFS} (that is to say, holding the control voltage V_{REFS} at the held terminal voltage V_{REF}), until the next round of sampling. In FIG. 4, the shaded areas represent sampling periods of the sampling performed above. The predetermined time ΔT2 is longer than the predetermined time ΔT1. The predetermined time ΔT2 is set such that the predetermined time ΔT2 is shorter than a minimum on-time assumed as a minimum value of a length of the off-period of the switching transistor M1.

The timing t_{A2} is a timing later than the timing t_{A1} by the predetermined time ΔT1, and the timing t_{A3} is a timing later than the timing t_{A2} by the predetermined time ΔT2. Thus, from the timing t_{A1} to closely before the timing t_{A2}, the control voltage V_{REFS} is held at the terminal voltage V_{REF} held last time by the circuit 110. Between the timings t_{A2} and t_{A3}, the terminal voltage V_{REF} at the timings t_{A2} and t_{A3} is directly set to be the control voltage V_{REFS}. Then, by holding the terminal voltage V_{REF} of the timing t_{A3} by the circuit 110, after the timing t_{A3} and before a timing t_{A6} of a next round of sampling below, the circuit 110 holds the control voltage V_{REFS} at the terminal voltage V_{REF} of the timing t_{A3}. In FIG. 4, a situation in which the control voltage V_{REFS} is consistent with the internal setting voltage V_{INTREF} is assumed.

On the other hand, accompanied with a falling edge of the control signal S_{CNT} at the timing t_{A1}, the slope voltage V_{SLP} starts increasing from the timing t_{A1}. At the timing t_{A4} after the timing t_{A3}, a state of “V_{SLP}<V_{REFS}” is switched to a state of “V_{SLP}>V_{REFS}”. A falling edge is generated in the comparison result signal S_{CMP} in response to the switching. The control logic 140 generates a rising edge in control signal S_{CNT} in response to the falling edge of the comparison result signal S_{CMP}. Thus, at the timing t_{A4}, a rising edge is generated in the control signal S_{CNT}. A rising edge in driving signal S_{DRV} is generated in response to the rising edge of the control signal S_{CNT}. Thus, the switching transistor M1 is turned on at the timing t_{A4}. As the switching transistor M1 is turned on and the switch voltage V_{SW} decreases drastically, the terminal voltage V_{REF} also in conjunction decreases drastically.

Moreover, accompanied with the rising edge of the control signal S_{CNT} at the timing t_{A4}, the transistor 123 is turned on, and thus the slope voltage V_{SLP} decreases drastically to 0 V. As the slope voltage V_{SLP} decreases and a state of “V_{SLP}<V_{REFS}” is restored, a rising edge is generated in the comparison result signal S_{CMP}. As a result, a length of the low level period of the comparison result signal S_{CMP} in each switching cycle is minute.

After a predetermined on-time T_{ON} has elapsed from the timing t_{A4}, the control logic 140 causes a falling edge to be generated in the control signal S_{CNT}. The timing t_{A5} is a timing later than the timing t_{A4} by the on-time T_{ON}. A falling edge is generated in driving signal S_{DRV} in response to the falling edge of the control signal S_{CNT} at the timing t_{A5}. Thus, the switching transistor M1 is turned off at the timing t_{A5}. The timing t_{A6} is a timing later than the timing t_{A5} by the predetermined time ΔT1.

The time in which the switching transistor M1 is set to be in an on state in each switching cycle is the on-time T_{ON}, and the time in which the switching transistor M1 is set to be in an off state is an off-time T_{OFF}. For a period from the timing t_{A1} to the timing t_{A5}, a length between the timings t_{A1} and t_{A4} is the off-time T_{OFF}, and a length between the timings t_{A4} and t_{A5} is the on-time T_{ON}.

In the control logic 140, a predetermined fixed time (a predetermined constant on-time) is set to be the on-time T_{ON}. In contrast, the off-time T_{OFF} changes in accordance with the control voltage V_{REFS}. Herein, the off-time T_{OFF} when “V_{REFS}=V_{INTREF}” is specifically referred to as a reference off-time. A sum of the reference off-time and the fixed on-time T_{ON} is equal to a reciprocal of a reference switching frequency f_{O}.

The reference switching frequency f_{O} is a frequency specified in specifications of the power supply control device 10, and the switching frequency f_{SW} is equal to the reference switching frequency f_{O} when a secondary output power PW_{OUT} in the current continuous mode is kept constant (wherein it is assumed that no jitter is added to the switching frequency f_{SW}). The current source 121 generates the current Ia corresponding to the internal setting voltage V_{INTREF} to have the sum of the off-time T_{OFF} and the on-time T_{ON} be equal to (1/f_{O}) when “V_{REFS}=V_{INTREF}” holds true.

The secondary output power PW_{OUT} is represented by a product of the output voltage V_{OUT} and the output current Jour, and is equivalent to a consumption power of the load LD. The secondary output power PW_{OUT} can also be simply represented as an output power PW_{OUT} in the description below. If it is assumed that the output voltage V_{OUT} is stable, an increase or decrease in the output power PW_{OUT} means an increase or decrease in the output current I_{OUT}.

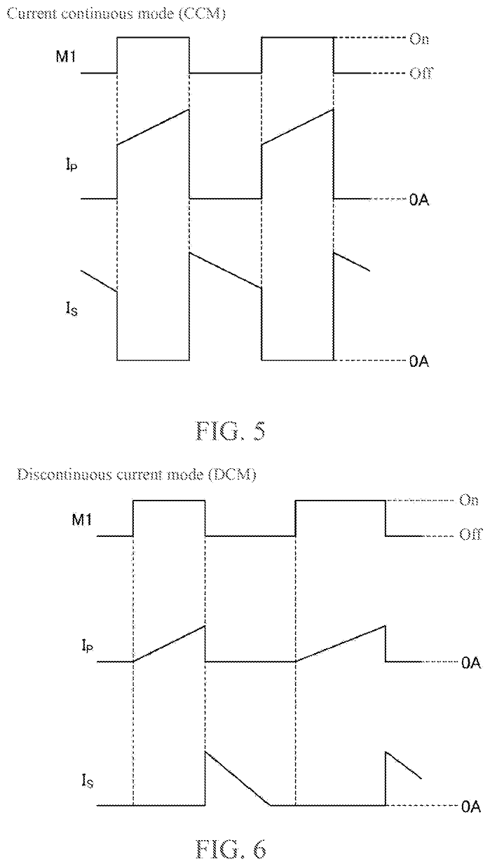

FIG. 5 shows waveforms of the primary current I_{P} and the secondary-current I_{S} in the current continuous mode. FIG. 6 shows waveforms of the primary current I_{P} and the secondary-current I_{S} in a discontinuous current mode. The current continuous mode is sometimes abbreviated as CCM and the discontinuous current mode is sometimes abbreviated DCM below. It is considered that each switching cycle begins when the switching transistor M1 is turned on. In each switching cycle, during the on-period of the switching transistor M1, the primary current I_{P} gradually increases, and then the secondary current I_{S} is generated when the switching transistor M1 is turned off. During the off-period of the switching transistor M1, the secondary current I_{S} gradually decreases. In the current continuous mode, before the secondary current I_{S} decreases to zero within the off-period of the switching transistor M1, the switching transistor M1 is turned on (that is to say, a next switching cycle begins). In the discontinuous current mode, after the secondary current I_{S} decreases to zero within the off-period of the switching transistor M1, the switching transistor M1 is turned on (that is to say, a next switching cycle begins).

Operation modes of the switching control circuit 100 includes the CCM and the DCM. That is to say, the switching control circuit 100 is able to use the CCM as an operation mode to switch drive the switching transistor M1, and is also able to use the DCM as an operation mode to switch drive the switching transistor M1. The switching control circuit 110 uses the CCM as the operation mode when a load is larger (that is to say, when the output power PW_{OUT} is larger), and uses the DCM as the operation mode when the load is lighter (that is to say, the output power PW_{OUT} is smaller).

A state in which the output power PW_{OUT} is kept at a constant power and the output voltage V_{OUT} is consistent with the target voltage V_{TG} in the CCM is referred to as a first balanced state.

Behaviors of the output power PW_{OUT} increasing from a constant power from the first balanced state as a starting point is described below. When the output power PW_{OUT} increases from a constant power in the CCM, the output voltage V_{OUT} is temporarily lower than the target voltage V_{TG}. A decrease in the output voltage V_{OUT} causes a decrease in the off-time T_{OFF} due to a decrease in the control voltage V_{REFS}. The decrease in the off-time T_{OFF} causes increases in an average current of the primary current I_{P} and an average current of the secondary current I_{S}, and the output voltage V_{OUT} increases accordingly. Then, a state in which the output voltage V_{OUT} is consistent with the target voltage V_{TG} is again restored. A state in which “V_{OUT}=V_{TG}” is again stable after the output power PW_{OUT} increases from the first balanced state as a starting point is referred to as a second balanced state. The average current of the primary current I_{P} and the average current of the secondary current I_{S} in the second balanced state are larger than the average current of the primary current I_{P} and the average current of the secondary current I_{S} in the first balanced state.

Behaviors of the output power PW_{OUT} decreasing from a constant power from the first balanced state as a starting point is described below. When the output power PW_{OUT} decreases from a constant power in the CCM, the output voltage V_{OUT} is temporarily higher than the target voltage V_{TG}. An increase in the output voltage V_{OUT} causes an increase in the off-time T_{OFF} due to an increase in the control voltage V_{REFS}. The increase in the off-time T_{OFF} causes decreases in the average current of the primary current I_{P} and the average current of the secondary current I_{S}, and the output voltage V_{OUT} decreases accordingly. Then, a state in which the output voltage V_{OUT} is consistent with the target voltage V_{TG} is again restored. A state in which “V_{OUT}=V_{TG}” is again stable after the output power PW_{OUT} decreases from the first balanced state as a starting point is referred to as a third balanced state. The average current of the primary current I_{P} and the average current of the secondary current I_{S} in the third balanced state are smaller than the average current of the primary current I_{P} and the average current of the secondary current I_{S} in the first balanced state.

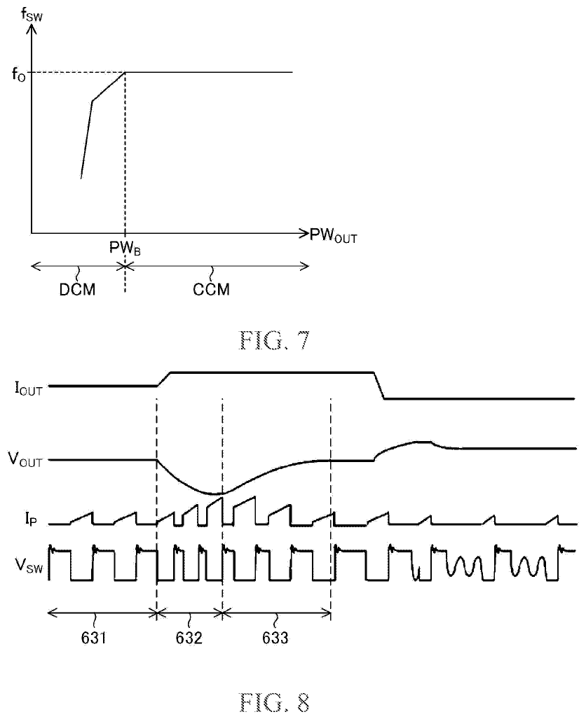

FIG. 7 shows a relationship between the output power PW_{OUT} and the switching frequency f_{SW}. However, in FIG. 7, it is assumed that no jitter is added to the switching frequency f_{SW}. Provided that the operation mode is the CCM, even if there is a change in the output power PW_{OUT}, a state of “V_{REFS}=V_{INTREF}” can be restored even after a transient response. Thus, when the operation mode is the CCM, if the transient response is omitted and it is assumed that no jitter is added to the switching frequency f_{SW}, the switching frequency f_{SW} is irrelevant from the output power PW_{OUT} and is consistent with the reference switching frequency f_{O}. The operation mode is the CCM when the output power PW_{OUT} is higher than a certain boundary power P_{WB}. The operation mode is the DCM when the output power PW_{OUT} is lower than the boundary power P_{WB}.

The operation mode changes from the CCM to the DCM when the output power PW_{OUT} further decreases by a constant amount or more from the third balanced state as a starting point. Further details of the above are given below. When the output power PW_{OUT} further decreases by a constant amount or more from the third balanced state as a starting point, the output voltage V_{OUT} becomes higher than the target voltage V_{TG}. An increase in the output voltage V_{OUT} causes an increase in the off-time T_{OFF} due to an increase in the control voltage V_{REFS}. The increase in the off-time T_{OFF} herein causes “I_{S}=0” within the off-period of the switching transistor M1, and a transition from the CCM to the DCM takes place. In the DCM, electrical power corresponding to the on-time T_{ON} is also transmitted from the primary side to the secondary side, so the state of “V_{OUT}>V_{TG}” persists in the DCM.

In the DCM, the on-time T_{ON} is kept unchanged and the off-time T_{OFF} increases as compared to that in the CCM, and so the switching frequency f_{SW} in the DCM is lower than the reference switching frequency f_{O}. In the DCM, as the output power PW_{OUT} decreases, the switching frequency f_{SW} reduces due to the increase in the control voltage V_{REFS}. Moreover, when the output power PW_{OUT} increases by more than a required amount from when the operation mode is set to the DCM, the control voltage V_{REFS} reduces due to the decrease in the output power PW_{OUT}, the amount of electrical power transmitted from the primary side to the secondary side increases as the switching frequency f_{SW} increases, and thus the CCM is restored.

FIG. 8 shows a timing diagram of a response to a change in the output power PW_{OUT}. In FIG. 8, the operation mode during periods 631 to 633 is the CCM. The period 631 corresponds to the first balanced state above. At a border between periods 631 and 632, the output power PW_{OUT} increases due to an increase in the output current I_{OUT}. The periods 632 and 633 are transient response periods accompanied with the increase in the output power PW_{OUT}. Within the period 632, the average current of the primary current I_{P} gradually increases due to a temporary increase in the switching frequency f_{SW}. Then, within the period 633, the switching frequency f_{SW} gradually restores to the reference switching frequency f_{O}. Further, the output power PW_{OUT} decreases due to the decrease in the output current I_{OUT}, the operation mode changes from the CCM to the DCM, and this is shown in FIG. 8.

### Adding of Jitter

In the description up to this point, it is assumed that no jitter is yet added to the switching frequency f_{SW}. The description below is given by considering that a jitter is added. Moreover, in this application, unless otherwise specified, adding a jitter refers to adding a jitter to the switching frequency f_{SW}.

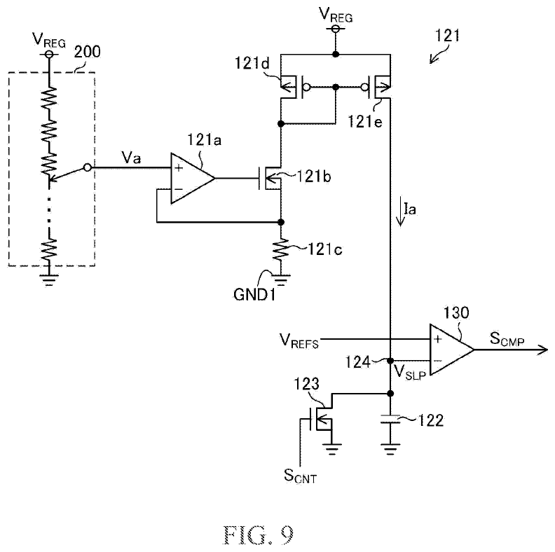

FIG. 9 shows a diagram of an internal circuit and peripheral circuits of the current source 121 in FIG. 3. The current source 121 includes an operational amplifier 121a, transistors 121b, 121d and 121e, and a resistor 121c. The transistor 121b is an N-channel MOSFET, and the transistors 121d and 121e are P-channel MOSFETs.

A voltage Va is applied to a non-inverting input terminal of the operational amplifier 121a. An output terminal of the operational amplifier 121a is connected to a gate of the transistor 121b. An inverting input terminal of the operational amplifier 121a is connected to a source of the transistor 121b, and is connected to the ground GND1 via the resistor 121c. A drain of the transistor 121b is connected to a drain and a gate of the transistor 121d and a gate of the transistor 121e. An internal power supply voltage VREG is supplied to a source of each of the transistors 121d and 121e. An internal power supply circuit (not shown) in the power supply control device 1 generates the internal power supply voltage VREG based on the input voltage V_{IN}. The internal power supply voltage VREG is a predetermined positive DC voltage. A drain of the transistor 121e is connected to a node 124.

The operational amplifier 121a controls a gate potential of the transistor 121b to have a voltage across two ends of the resistor 121c be consistent with the voltage Va. The voltage across two ends the resistor 121c is a voltage drop in the resistor 121c caused by a drain current of the transistor 121b flowing into the resistor 121c. The drain current of the transistor 121b is consistent with a drain current of the transistor 121d. Since the transistors 121d and 121e form a current mirror circuit, a drain current proportional to the drain current of the transistor 121d is generated in the transistor 121e. Thus, the drain current of the transistor 121e is the current Ia supplied to the node 124.

The jitter adding circuit 200 generates and supplies the voltage Va to the non-inverting input terminal of the operational amplifier 121a. The voltage Va changes due to the jitter adding circuit 200 when the jitter adding circuit 200 operates. As described below, under the control of the jitter control circuit 300, the operation of the jitter adding circuit 200 is sometimes stopped. In the description below, a jitter adding state refers to a state in which the voltage Va changes by an operation performed by the jitter adding circuit 200. In the jitter adding state, a jitter (a fluctuation) is added to the switching frequency f_{SW} due to the change in the voltage Va. On the other hand, a state in which the operation of the jitter adding circuit 200 is stopped is referred to a jitter stopped state. In the jitter stopped state, the voltage Va is fixed.

If the voltage Va increases, the current Ia increases. The increase in the current Ia causes an increase in a slope of the slope voltage V_{SLP} during the off-period of the switching transistor M1. In the CCM, the increase in the slope of the slope voltage V_{SLP} causes an increase in the switching frequency f_{SW} due to a decrease in the off-time T_{OFF} (the same applies to the DCM). Conversely, if the voltage Va reduces, the current Ia decreases. The decrease in the current Ia causes a decrease in the slope of the slope voltage V_{SLP} during the off-period of the switching transistor ML. In the CCM, the decrease in the slope of the slope voltage V_{SLP} causes a decrease in the switching frequency f_{SW} due to an increase in the off-time T_{OFF} (the same applies to the DCM).

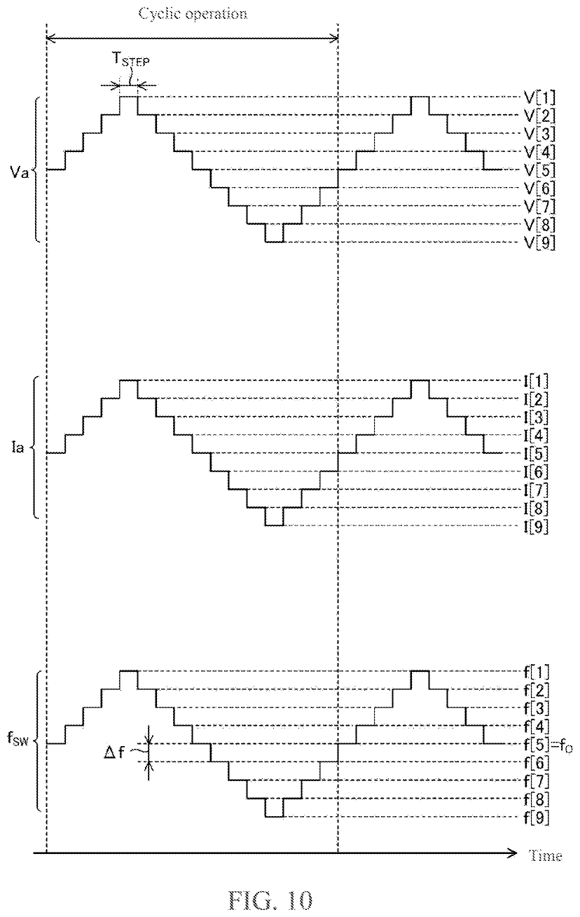

FIG. 10 depicts a situation where the voltage Va, the current Ia and the switching frequency f_{SW} are changed in the jitter adding state in CCM. In the jitter adding state, the jitter adding circuit 200 sets any one of 9 voltages V[1] to V[9] to be the voltage Va. As a result, any one of currents I[1] to I[9] in the current source 121 is set to be the current Ia. As such, in the jitter adding state in the CCM, the switching frequency f_{SW} is set to be any one of 9 frequencies f[1] to f[9]. For any integer i, when the voltage V[i] is set to be the voltage Va, the current I[i] is set to be the current Ia and the frequency f[i] is set to be the switching frequency f_{SW}. Moreover, the frequency f[i] set to the switching frequency f_{SW} means that a target of the switching frequency f_{SW} is set to be the frequency f[i]; however, an offset sometimes occurs during such as a transient response.

For any integer i, “V[i]>V[i+1]”, “I[i]>I[i+1]” and “f[i]>f[i+1]” hold true. For any integer i, the frequency f[i] is higher than the frequency f[i+1] by a step size Δf. For example, the frequencies f[1], f[5] and f[9] are respectively 381 kHz, 363 kHz and 345 kHz. In this case, for any integer i, the frequency f[i] is higher than the frequency f[i+1] by 4.5 kHz (that is to say, the step size Δf is 4.5 kHz). The frequency f[5] is consistent with the reference switching frequency f_{O}. Thus, in the CCM, in the jitter adding state, the switching frequency f_{SW} varies within a range between a frequency (f_{O}+4·Δf) and a frequency (f_{O}-4·Δf).

In the jitter adding state, the jitter adding circuit 200 is provided with 1st to 9^{th} unit periods. The i^{th} unit period is a period in which the voltage V[i] is set to be the voltage Va. In the jitter adding state, the jitter adding circuit 200 performs a cyclic operation. In the cyclic operation, starting from the 5th unit period, the 4^{th}, 3^{rd}, 2^{nd} and 1st unit periods are sequentially provided, the 2^{nd}, 3^{rd}, 4^{th}, 5^{th}, 6^{th}, 7^{th}, 8^{th} and 9^{th} unit periods are next sequentially provided, then the 8^{th}, 7^{th} and 6^{th} unit periods are sequentially provided, and the cyclic operation returns to the 5^{th} unit period. That is to say, in the cyclic operation, the jitter adding circuit 200, starting from a state in which the voltage V[5] is set to be the voltage Va, increases the voltage Va in steps from the voltage V[5] to the voltage V[1], decreases the voltage Va in steps from the voltage V[1] to the voltage V9, and then increases the voltage Va in steps from the voltage V[9] to the voltage V[5]. Each of the unit periods has a length of a predetermined unit time T_{STEP}. The unit time T_{STEP} is, for example, 500 s. In this case, one round of the cyclic operation has a length of 8 ms.

In the jitter adding state, the jitter adding circuit 200 repeats the cyclic operation. Thus, when the jitter adding circuit 200 operates in the CCM, the switching frequency f_{SW} repeatedly fluctuates up and down within the frequency range between the frequency f[1] and f[9]. Accordingly, for the switching frequency f_{SW}, an effect of spectrum spreading can be obtained, and a peak level of radiation noise of the DC/DC converter 1 (the power supply control device 10) can be reduced.

The jitter adding circuit 200 can be, for example, a circuit that divides the internal power supply voltage VREG using a plurality of voltage dividing resistors and outputs a voltage obtained by dividing the voltage as the voltage Va. At this point, each time the unit time T_{STEP} elapses, the jitter adding circuit 200 changes a voltage division ratio (that is, a ratio of the internal power supply voltage V_{RE}G to the voltage Va) so that a step change in the voltage Va shown in FIG. 10 can be obtained. The jitter adding circuit 200 can also be formed by using a digital-to-analog converter (DAC) having a ladder resistor.

In the jitter stopped state, a predetermined fixed voltage is used as the voltage Va and supplied to the non-inverting input terminal of the operational amplifier 121a. The fixed voltage herein is the voltage V[5]. Thus, when the operation of the jitter adding circuit 200 is stopped in the CCM, if a transient response is omitted, a state of “f_{SW}=f[5]” is maintained. In the jitter stopped state, the voltage V[5] can be supplied from the jitter adding circuit 200 to the non-inverting input terminal of the operational amplifier 121a, or the voltage V[5]can be supplied from other circuits (not shown) to the non-inverting input terminal of the operational amplifier 121a. Moreover, an example in which the switching frequency f_{SW} set to be variable in 9 steps in the jitter adding state is given; however, the number of steps by which the switching frequency f_{SW} is variable can also be other than 9.

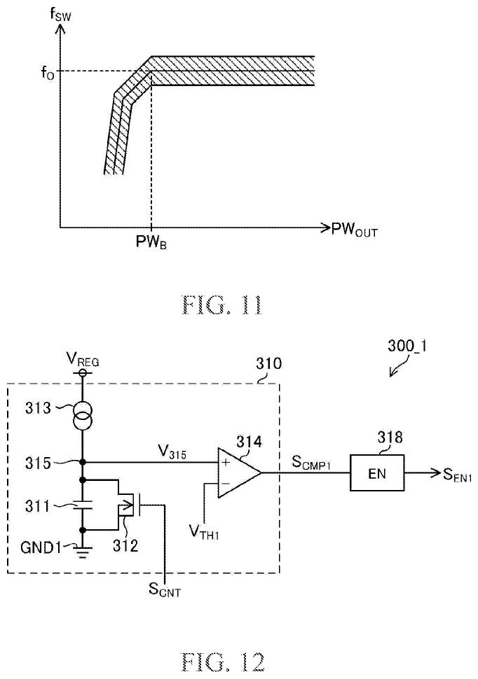

FIG. 11 shows a relationship between the output power PW_{OUT} and the switching frequency f_{SW} in a hypothetical configuration. In the hypothetical configuration, a jitter is added to the switching frequency f_{SW} regardless of whether the operation mode is the CCM or the DCM. In FIG. 11, the shaded areas represent a variation range of the switching frequency f_{SW} in the hypothetical configuration.

Although an effect of reducing a peak level of radiation noise can be achieved by means of adding a jitter, some ripples are generated in the output voltage V_{OUT} when the switching frequency f_{SW} is intentionally varied. In case of the CCM, the switching frequency f_{SW} can be varied as expected, and the ripples in the output voltage V_{OUT} generated can also be small enough within a tolerable range.

On the other hand, the DCM is an operation mode that changes the switching frequency f_{SW} by larger extents according to the output power PW_{OUT}, so the switching frequency f_{SW} can easily become unstable if a jitter is intentionally added in the DCM. Moreover, in the DCM, after a state of “I_{S}=0” is established within the off-period of the switching transistor M1, the switch voltage V_{SW} oscillates. There are cases where the control voltage V_{REFS} deviates from an appropriate voltage due to the influence of the oscillation, and such offset also causes the switching frequency f_{SW} to be unstable. In particularly, if a jitter is continually added around a timing at which the operation mode changes from the DCM to the CCM, the switching frequency f_{SW} becomes too unstable such that large ripples occur in the output voltage V_{OUT}. The same applies to around a time at which the operation mode changes from the CCM to the DCM.

Considering the situations above, in the power supply control device 10, the jitter control circuit 300 is provided to control the jitter adding circuit 200. The jitter control circuit 300 controls whether to add a jitter to the switching frequency f_{SW} by controlling (by controlling the operation of) the jitter adding circuit 200. That is to say, the jitter control circuit 300 sets the state of the jitter adding circuit 200 to the jitter adding state or the jitter stopped state according to a predetermined indicator. In particular, the jitter control circuit 300 stops adding a jitter to the switching frequency f_{SW} by setting the state of the jitter adding circuit 200 to the jitter stopped state in the DCM. Accordingly, the switching frequency f_{SW} can be suppressed from getting too unstable, and as a result, ripples in the output voltage V_{OUT} can be reduced. Moreover, it is considered that the jitter control circuit 300 is provided separately from the jitter adding circuit 200 herein; however, it can also be understood as that the jitter adding circuit 200 is provided in the jitter control circuit 300.

In the multiple embodiments below, several specific operation examples, application techniques and variation techniques are described. Unless otherwise specified and without causing any contradiction, the items described in embodiments of the preceding description can be applied to embodiments in the following description. In the various implementation examples, the description of the embodiments are prioritized in the presence of any items contradictory from the items described above. Moreover, provided there are not contradictions, the items described in any one of the multiple embodiments below are also applicable to another other embodiment (that is to say, any two or more of the embodiments can be combined as desired).

### First Embodiment

The first embodiment is described below. According to FIG. 7, it can be understood that the switching frequency f_{SW} when the operation mode is the CCM is higher than the switching frequency f_{SW} when the operation mode is the DCM.

Considering the situations above, the jitter control circuit 300 of the first embodiment includes a frequency detection circuit that detects the switching frequency f_{SW}, and controls whether to add a jitter to the switching frequency f_{SW} based on a detection result of the switching frequency f_{SW}.

More specifically, the jitter control circuit 300 of the first embodiment determines which of the CCM and the DCM the operation mode is based on the switching frequency f_{SW} detected by the frequency detection circuit. When it is determined that the operation mode is the CCM, the circuit 300 adds a jitter to the switching frequency f_{SW} by setting the state of the jitter adding circuit 200 to be the jitter adding state. When it is determined that the operation mode is the DCM, the circuit 300 stops adding a jitter to the switching frequency f_{SW} by setting the state of the jitter adding circuit 200 to be the jitter stopped state.

FIG. 12 shows a jitter control circuit 300_1 including a frequency detection circuit 310. The jitter control circuit 300_1 is an example of the jitter control circuit 300 in FIG. 3. The frequency detection circuit 310 includes a capacitor 311, a transistor 312, a constant current source 313 and a comparator 314. The transistor 312 is an N-channel MOSFET.

One end of the capacitor 311 and a drain of the transistor 312 are connected to a node 315. The other end of the transistor 312 and a source of the transistor 312 are connected to the ground GND1. The control signal S_{CNT} is input to a gate of the transistor 312. The constant current source 313 supplies a constant current from a terminal applied with an internal power supply voltage VREG to the node 315. A voltage at the node 315 is referred to as a voltage V₃₁₅. The voltage V₃₁₅ is supplied to a non-inverting input terminal of the comparator 314. A predetermined threshold voltage V_{TH1} is supplied to an inverting input terminal of the comparator 314. The threshold voltage V_{TH1} has a predetermined positive DC voltage value. The comparator 314 compares the voltage V₃₁₅ with the threshold voltage V_{TH1}, and outputs a signal S_{CMP1} based on a comparison result thereof. The signal S_{CMP1} has a high level when “V₃₁₅>V_{TH1}” holds true, and the signal S_{CMP1} has a low level when “V₃₁₅<V_{TH1}” holds true. When “V₃₁₅=V_{TH1}” holds true, the signal S_{CMP1} has a high level or a low level.

An enable circuit 318 used for a jitter is provided in the jitter control circuit 300_1. The enable circuit 318 generates an enable signal S_{EN1} having a value of “1” or “0” based on the signal S_{CMP1}, and provides the enable signal S_{EN1} to the jitter adding circuit 200. The enable signal S_{EN1} in “1” is a signal that allows or provides an instruction for adding a jitter, and the enable signal S_{EN1} in “0” is a signal that prohibits adding a jitter. Thus, the jitter adding circuit 200 is set to be the jitter adding state during a period in which the enable signal S_{EN1} has a value of “1”, and is set to be the jitter stopped state during a period in which the enable signal S_{EN1} has a value of “0”.

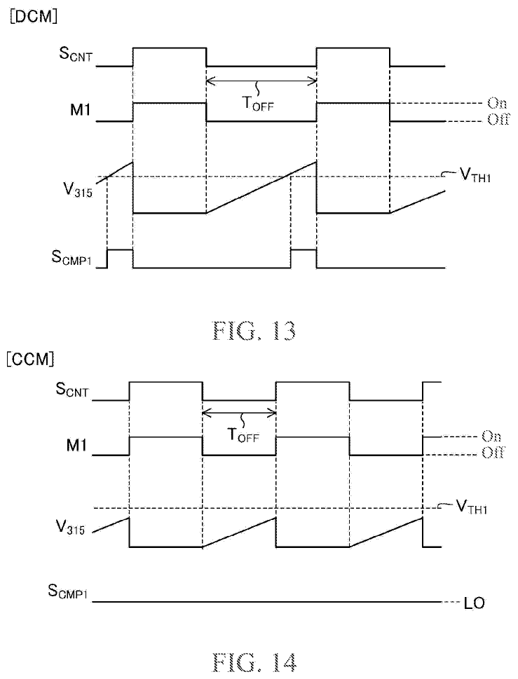

FIG. 13 shows waveforms of several signals in the DCM. FIG. 14 shows waveforms of several signals in the CCM. During a high level period of the control signal S_{CNT}, the transistor 312 is turned on, so the voltage V₃₁₅ is substantially 0 V, and the enable signal S_{CMP1} has a low level. During a low level period of the control signal S_{CNT}, the transistor 312 is turned off, so the voltage V₃₁₅ monolithically increases due to the constant current from the constant current source 313. The off-time T_{OFF} in the DCM is longer, so a high level of the signal S_{CMP1} is generated in each switching cycle. In contrast, the off-time T_{OFF} in the CCM is shorter, so the signal S_{CMP1} is kept at a low level in each switching cycle.

If a first switching condition is established in the state of “S_{EN1}=0”, the enable circuit 318 determines that the operating mode is the CCM (determines that the operating mode is switched from the DCM to the CCM), and changes the value of enable signal S_{EN1} from a value of “O” to a value of “1”. When the signal S_{CMP1} is kept at a low level for a time of more than a predetermined time T_{DEL1A}, the first switching condition is established. If the first switching condition is not established in the state of “S_{EN1}=0”, the enable circuit 318 determines that the operating mode is the DCM, and keeps the value of the enable signal S_{EN1} at “0”.

The enable circuit 318 determines whether a second switching condition is established by monitoring whether a rising edge is generated in the signal S_{CMP1} in the state of “S_{EN1}=1”. If the second switching condition is established, the enable circuit 318 determines that the operating mode is the DCM (determines that the operating mode is switched from the CCM to the CCM), and changes the value of enable signal S_{EN1} from a value of “1” to a value of “0”. For example, the second switching condition is established even if only one rising edge is generated in the signal S_{CMP1}. Alternatively, for example, it can also be set that the second switching condition is established when a rising edge is generated N_{TH}1 times in the signal S_{CMP1} within a predetermined determination time T_{DET1B}. If the second switching condition is not established in the state of “S_{EN1}=1”, the enable circuit 318 determines that the operating mode is the CCM, and keeps the value of the enable signal S_{EN1} at “1”.

The determination times T_{DET1A} and T_{DET1B} are sufficiently longer than a reciprocal of the reference switching frequency f_{O}, and are for example, several times or hundreds of times the reference switching frequency f_{O}. It does not matter whether the determination times T_{DET1A} and T_{DET1B} match or do not match. N_{TH1} represents any integer greater than or equal to 2. Moreover, a default value of the enable signal S_{EN1} is “0”.

The frequency detection circuit 310 is a circuit that detects whether the switching frequency f_{SW} is higher than a predetermined frequency based on the threshold voltage V_{TH1}, that is, a circuit that detects the switching frequency f_{SW} in two levels.

In the frequency detection circuit 310, the switching frequency f_{SW} can be divided into three levels or more to perform the detection, and set the value of the enable signal S_{EN1} based on a detection result thereof. For example, the variation method below can be used. The frequency detection circuit 310 of the variation method detects a level relationship between the switching frequency f_{SW} and each of a predetermined upper frequency and a predetermined lower frequency based on the control signal S_{CNT}. The upper frequency is higher than the lower frequency. For example, the upper frequency is higher than the reference switching frequency f_{O}, and the lower frequency is lower than the reference switching frequency f_{O}. Moreover, when it is detect in the state of “S_{EN1}=0” that the switching frequency f_{SW} is higher than the upper frequency, the enable circuit 318 determines that the operating mode is the CCM (determines that the operating mode is switched from the DCM to the CCM), and changes the value of enable signal S_{EN1} from a value of “0” to a value of “1”. When it is detect in the state of “S_{EN1}=0” that the switching frequency f_{SW} is lower than the lower frequency, the enable circuit 318 determines that the operating mode is the DCM (determines that the operating mode is switched from the CCM to the DCM), and changes the value of enable signal S_{EN1} from a value of “1” to a value of “0”.

### Second Embodiment

The second embodiment is described below. In the DCM, once the secondary current I_{S} decreases to zero within the off-period of the switching transistor M1, and a voltage of the anode of the rectifier diode D oscillates due to free resonance. Such oscillation does not occur in the CCM. Thus, in the second embodiment, it is determined which of the CCM and the DCM the operation mode is by detecting the presence of such oscillation.

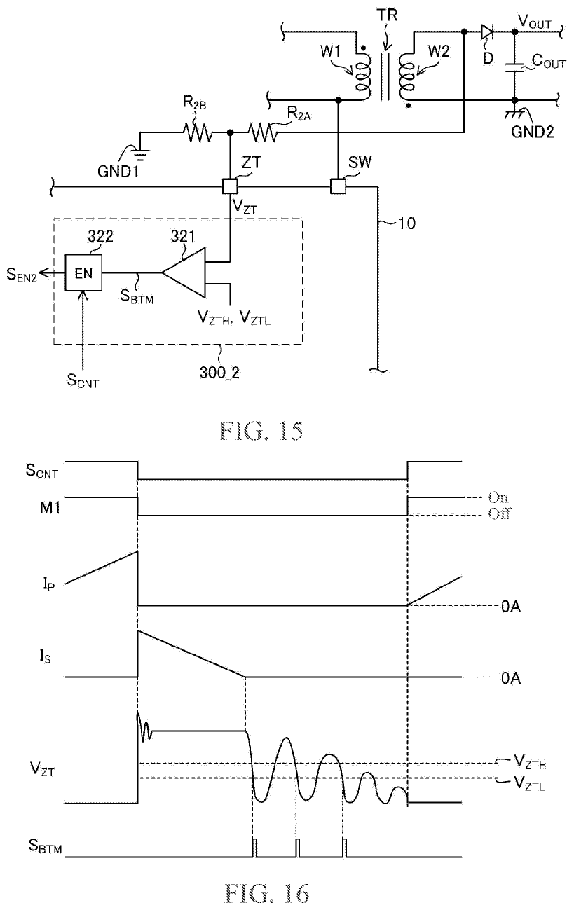

FIG. 15 shows a partial circuit diagram of the DC/DC converter 1 of the second embodiment. In the second embodiment, a jitter control circuit 300_2 in FIG. 15 is used as the jitter control circuit 300. In the second embodiment, a terminal ZT is provided as an external terminal of the power supply control device 10, and voltage dividing resistors R_{2A} and R_{2B} are provided in the DC/DC converter 1. A first end of the voltage dividing resistor R_{2A} is connected to the anode of the rectifier diode D (hence connected to the first end of the secondary winding W2). A second end of the voltage dividing resistor R_{2A} is connected to the terminal ZT, and is connected to a first end of the voltage dividing resistor R_{2B}. A second terminal of the voltage dividing resistor R_{2B} is connected to the ground GND1. A voltage at the terminal ZT is referred to as a terminal voltage V_{ZT} (a comparison voltage).

The jitter control circuit 300_2 further includes a voltage comparison circuit 321 having one or more comparators, and an enable circuit 322. The voltage comparison circuit 321 is connected to the terminal ZT and receives the terminal voltage V_{ZT}. The voltage of the anode of the rectifier diode D can be divided by the voltage dividing resistor R_{2A} and R_{2B} by using the potential of the ground GND1 as a reference, and the terminal voltage V_{ZT} can be obtained by the voltage dividing. The voltage comparison circuit 321 compares the terminal voltage V_{ZT} with a predetermined threshold voltage, and outputs a valley detection signal S_{BTM} corresponding to a comparison result thereof to the enable circuit 322.

Herein, it is assumed that two threshold voltages V_{ZTH} and V_{ZTL} are used in the voltage comparison circuit 321. The threshold voltages V_{ZTH} and V_{ZTL} are positive DC voltages higher than the potential of the ground GND, and “V_{ZTH}>V_{ZTL}” holds true. The voltage comparison circuit 321 in principle holds the valley detection signal S_{BTM} at a low level, and sets the valley detection signal S_{BTM} to a high level within a predetermined minute time when a valley detection condition below is established. The valley detection signal S_{BTM} is set to a high level within the minute time each time when the valley detection condition is established.

FIG. 16 shows a timing diagram associated with operations of the jitter control circuit 300_2. FIG. 16 depicts the state of the switching transistor M1 and waveforms of several signals when the DC/DC converter 1 operates in the DCM.

The voltage comparison circuit 321 has a function of comparing a level relationship between the terminal voltage V_{ZT} and each of the threshold voltages V_{ZTH} and V_{ZTL}. When “V_{ZT}<V_{ZTL}” is established after “V_{ZT}>V_{ZTH}” is established, the voltage comparison circuit 321 determines that the valley detection condition is established. In the example in FIG. 16, within the off-period of the switching transistor M1 in one switching cycle, the valley detection condition valley is established three times, and the valley detection signal S_{BTM} is set to a high level within the minute time each time when the valley detection condition is established.

The enable circuit 322 generates an enable signal S_{EN2} having a value of “1” or “0” based on the valley detection signal S_{BTM}, and provides the enable signal S_{EN2} to the jitter adding circuit 200. The enable signal S_{EN2} in “1” is a signal that allows or provides an instruction for adding a jitter, and the enable signal S_{EN2} in “0” is a signal that prohibits adding a jitter. Thus, the jitter adding circuit 200 is set to be the jitter adding state during a period in which the enable signal S_{EN2} has a value of “1”, and is set to be the jitter stopped state during a period in which the enable signal S_{EN2} has a value of “0”. Moreover, a default value of the enable signal S_{EN2} is “0” (but it can also be “1”).

Within the off-period of the switching transistor M1 in one switching cycle (that is, after a falling edge is generated in the control signal S_{CNT} and before a next rising edge is generated in the control signal S_{CNT}), the enable circuit 322 counts the number of times of a rising edge (or the number of times of a falling edge) generated in the valley detection signal S_{BTM}. The enable circuit 322 can determine whether a current timing belongs to the off-period of the switching transistor M1 based on the control signal S_{CNT} (or based on the driving signal S_{DRV}).

Moreover, when the number counted is two or more, the enable circuit 322 determines that the operation mode is the DCM and sets the enable signal S_{EN2} to a value of “0”. By setting “S_{EN2}=0”, addition of the jitter to the switching frequency f_{SW} is stopped. When the number counted is one or less, the enable circuit 322 determines that the operation mode is the CCM and sets the enable signal S_{EN2} to a value of “1”. By setting “S_{EN2}=1”, a jitter is added to the switching frequency f_{SW}. The reason for the above is that, the free oscillation is not generated when the operation mode is the CCM, and so the number of the count does not become two or more.

Herein, a method of using two threshold voltages V_{ZTH} and V_{ZTL} in order to reduce erroneous detection caused by such as noise is described. However, a variation method of generating the valley detection signal S_{BTM} merely based on a comparison between the terminal voltage V_{ZT} and the threshold voltage V_{ZTL} can also be used. When the state of “V_{ZT}>V_{ZTL}” changes to the state of “V_{ZT}<V_{ZTL}”, the voltage comparison circuit 321 of the variation method determines that the valley detection condition is established.

### Third Embodiment

The third embodiment is described below. Once the switching transistor M1 is turned on, the switch current I_{SW} starts to increase from zero in the DCM, and in comparison, the switch current I_{SW} starts to increase from a state of greater than zero in the CCM. In the third embodiment, it is determined which of the CCM and the DCM the operation mode is by using the difference above.

FIG. 17 shows a partial circuit diagram of the DC/DC converter 1 of the third embodiment. In the third embodiment, a jitter control circuit 300_3 in FIG. 17 is used as the jitter control circuit 300. The jitter control circuit 300_3 includes a current detection circuit 331, a comparator 332 and an enable circuit 333.

The current detection circuit 331 detects the switch current I_{SW}, and outputs a voltage V₁ indicating a detection value of the switch current I_{SW}. The comparator 332 compares the voltage V₁ with a predetermined threshold voltage V_{TH3}, and generates and outputs a signal S_{CMP3} corresponding to a comparison result thereof. The threshold voltage V_{TH3} has a predetermined positive DC voltage value. The comparator 332 outputs the signal S_{CMP3} at a high level when “V_{IN}>V_{TH3}” holds true, the signal S_{CMP3} at a low level when “V₁<V_{TH3}” holds true, and outputs the signal S_{CMP3} at a high level or a low level when “V₁=V_{TH3}” holds true.

The enable circuit 333 generates an enable signal S_{EN3} having a value of “1” or “0” based on the signal S_{CMP3}, and provides the enable signal S_{EN3} to the jitter adding circuit 200. The enable signal S_{EN3} in “1” is a signal that allows or provides an instruction for adding a jitter, and the enable signal S_{EN3} in “0” is a signal that prohibits adding a jitter. Thus, the jitter adding circuit 200 is set to be the jitter adding state during a period in which the enable signal S_{EN3} has a value of “1”, and is set to be the jitter stopped state during a period in which the enable signal S_{EN3} has a value of “0”. Moreover, a default value of the enable signal S_{EN3} is “0” (but it can also be “1”).

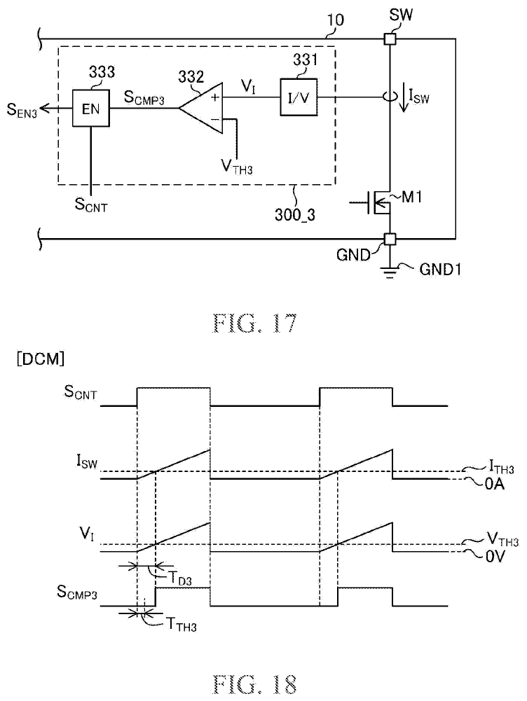

FIG. 18 and FIG. 19 show timing diagrams associated with operations of the jitter control circuit 300_3. FIG. 18 depicts waveforms of several signals when the DC/DC converter 1 operates in the DCM. FIG. 19 depicts waveforms of several signals when the DC/DC converter 1 operates in the CCM.

A value of the voltage V₁ is proportional to a value (the detection value) of the switch current I_{SW} by a positive proportion coefficient. When “V₁=V_{TH3}”, the value of the voltage V₁ is set to be consistent with the value of a predetermined threshold current I_{TH3}. As such, a circuit that determines a magnitude relationship between the voltage V₁ and the threshold current I_{TH3} can be formed by the current detection circuit 331 and the comparator 332. The signal S_{CMP3} has a high level when “I_{SW}>I_{TH3}” holds true, the signal S_{CMP3} has a low level when “I_{SW}<I_{TH3}” holds true, and signal S_{CMP3} has a high level or a low level when “I_{SW}=I_{TH3}” holds true.

The signal S_{CMP3} and the control signal S_{CNT} are input to the enable circuit 333. The enable circuit 333 measures a time T_{D3} from after a rising edge is generated in the control signal S_{CNT} to when a rising edge is generated in the signal S_{CMP3}, and compares the measured time T_{D3} with a predetermined time T_{TH3}. The time T_{D3} is equivalent to a time from when the switching transistor M1 is turned on until the switch current I_{SW} reaches the threshold current I_{TH3}.

The enable circuit 333 determines that the operation mode is the DCM when the measured time T_{D3} is more than the predetermined time T_{TH3}, and sets the enable signal S_{EN3} to have a value of “0”. By setting “S_{EN3}=0”, addition of the jitter to the switching frequency f_{SW} is stopped. The enable circuit 333 determines that the operation mode is the CCM when the measured time T_{D3} is less than the predetermined time T_{TH3}, and sets the enable signal S_{EN3} to have a value of “1”. By setting “S_{EN3}=1”, a jitter is added to the switching frequency f_{SW}.

A situation where “T_{D3}>T_{TH3}” is depicted in FIG. 18 corresponding to the DCM. In FIG. 19 corresponding to the CCM, since the measured time T_{D3} is minute, the drawing of the measured time T_{D3} is omitted.

### Fourth Embodiment

The fourth embodiment is described below. A peak of the switch current I_{SW} is lower in the DCM and higher in the CCM. In the fourth embodiment, whether a jitter is to be added is determined by considering the situation above.

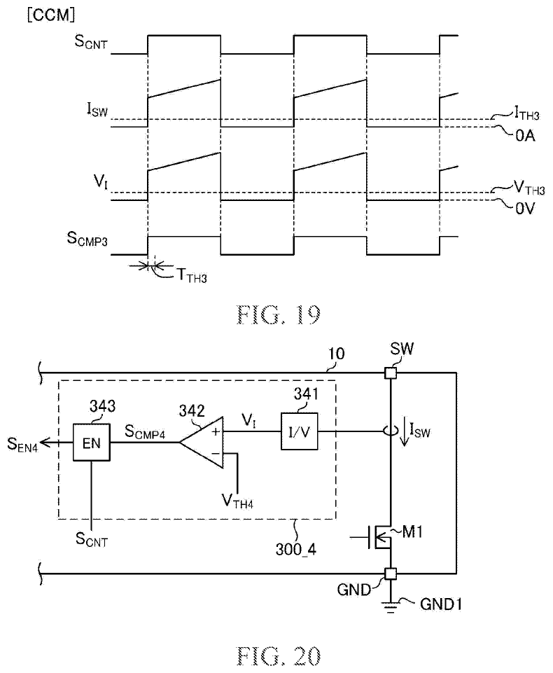

FIG. 20 shows a partial circuit diagram of the DC/DC converter 1 of the fourth embodiment. In the fourth embodiment, a jitter control circuit 300_4 in FIG. 20 is used as the jitter control circuit 300. The jitter control circuit 300_4 includes a current detection circuit 341, a comparator 342 and an enable circuit 343.

The current detection circuit 341 detects the switch current I_{SW}, and outputs a voltage V₁ indicating a detection value of the switch current I_{SW}. The current detecting circuit 341 is the same as the current detecting circuit 331 in FIG. 17. The comparator 342 compares the voltage V₁ with a predetermined threshold voltage V_{TH4}, and generates and outputs a signal S_{CMP4} corresponding to a comparison result thereof. The threshold voltage V_{TH4} has a predetermined positive DC voltage value. The comparator 342 outputs the signal S_{CMP4} at a high level when “V_{IN}>V_{TH4}” holds true, the signal S_{CMP4} at a low level when “V₁<V_{TH4}” holds true, and outputs the signal S_{CMP4} at a high level or a low level when “V₁=V_{TH4}” holds true.

The enable circuit 343 generates an enable signal S_{EN4} having a value of “1” or “0” based on the signal S_{CMP4}, and provides the enable signal S_{EN1} to the jitter adding circuit 200. The enable signal S_{EN4} in “1” is a signal that allows or provides an instruction for adding a jitter, and the enable signal S_{EN4} in “0” is a signal that prohibits adding a jitter. Thus, the jitter adding circuit 200 is set to be the jitter adding state during a period in which the enable signal S_{EN4} has a value of “1”, and is set to be the jitter stopped state during a period in which the enable signal S_{EN4} has a value of “0”. Moreover, a default value of the enable signal S_{EN4} is “0” (but it can also be “1”).

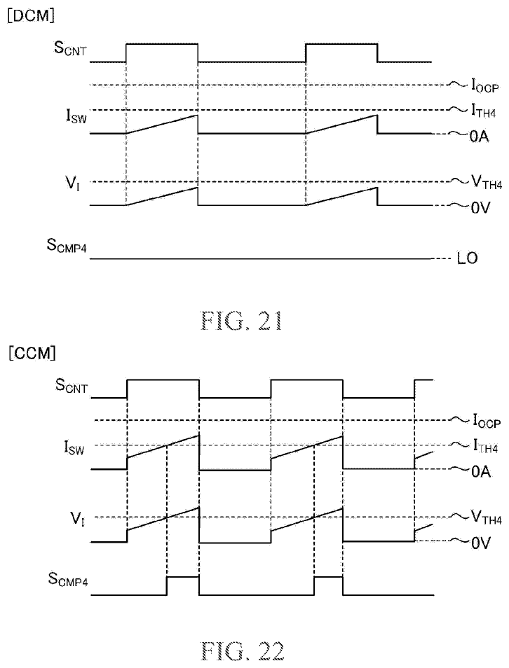

FIG. 21 and FIG. 22 show timing diagrams associated with operations of the jitter control circuit 300_4. FIG. 21 depicts waveforms of several signals when the DC/DC converter 1 operates in the DCM. FIG. 22 depicts waveforms of several signals when the DC/DC converter 1 operates in the CCM.

A value of the voltage V₁ is proportional to a value (the detection value) of the switch current I_{SW} by a positive proportion coefficient. When “V₁=V_{TH4}”, the value of the voltage V₁ is set to be consistent with the value of a predetermined threshold current I_{TH4}. As such, a circuit that determines a magnitude relationship between the voltage V₁ and the threshold current I_{TH4} can be formed by the current detection circuit 341 and the comparator 342. The signal S_{CMP4} has a high level when “I_{SW}>I_{TH4}” holds true, the signal S_{CMP4} has a low level when “I_{SW}<I_{TH4}” holds true, and signal S_{CMP4} has a high level or a low level when “I_{SW}=I_{TH4}” holds true.

The signal S_{CMP4} and the control signal S_{CNT} are input to the enable circuit 343. The enable circuit 343 determines whether the switch current I_{SW} has reached the threshold current I_{TH4} during the on-period of the switching transistor M1 based on the signals S_{CMP4} and S_{CNT}.

When a period in which the signal S_{CMP4} is at a high level is present in a high level period of the control signal S_{CNT}, the enable circuit 343 determines that the switch current I_{SW} reaches the threshold current I_{TH4} during the on-period of the switching transistor M1, and sets the enable signal S_{EN4} to have a value of “1”. By setting “S_{EN4}=1”, a jitter is added to the switching frequency f_{SW}. When a period in which the signal S_{CMP4} is at a high level is absent in a high level period of the control signal S_{CNT}, the enable circuit 343 determines that the switch current I_{SW} has not yet reached the threshold current I_{TH4} during the on-period of the switching transistor M1, and sets the enable signal S_{EN4} to have a value of “0”. By setting “S_{EN4}=0”, addition of the jitter to the switching frequency f_{SW} is stopped.

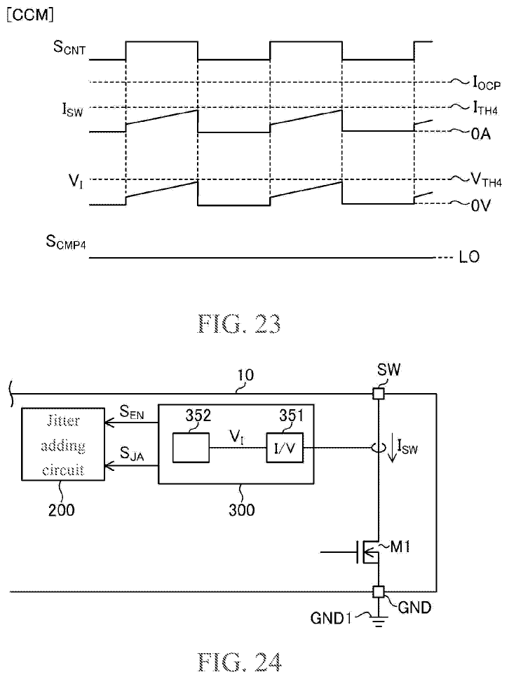

When the operation mode is the DCM, as shown in FIG. 21, the peak of the switch current I_{SW} is lower than the threshold current I_{TH4}. In the example in FIG. 22 corresponding to the CCM, the peak of the switch current I_{SW} is higher than the threshold current I_{TH4}. However, even when the operation mode is the CCM, as shown in FIG. 23, it is still possible that the peak of the switch current I_{SW} is lower than the threshold current I_{TH4}. Moreover, when it is said that the peak of the switch current I_{SW} is lower or higher than the threshold current I_{TH4}, it specifically means that the peak (a maximum value) of the switch current I_{SW} is lower or higher than a value of the threshold current I_{TH4}.

In the CCM, whether the peak of the switch current I_{SW} has reached the threshold current I_{TH4} is dependent on the output power PW_{OUT} (the consumption power of the load LD). When the operation mode is the CCM, the average current and the peak of the switch current I_{SW} during the on-period of the switching transistor M1 increase as the output power PW_{OUT} increases, and decrease as the output power PW_{OUT} decreases. When the operation mode is the CCM, if the switch current I_{SW} has reached the threshold current I_{TH4}, the jitter control circuit 330_4 sets the enable signal S_{EN4} to have a value of “1”; even if the operation mode is the CCM, if the switch current I_{SW} has not yet reached the threshold current I_{TH4}, the jitter control circuit 330_4 sets the enable signal S_{EN4} to have a value of “0”.

Moreover, as described above, the overcurrent protection circuit 160 detects a magnitude relationship between the switch current I_{SW} and a predetermined protection current I_{OCP}, and generates and outputs the overcurrent protection signal S_{OCP} indicating a detection result thereof. When “I_{SW}>I_{OCP}” holds true, the overcurrent protection signal S_{OCP} having a high level is generated and output. The overcurrent protection signal S_{OCP} is input to the control logic 140. After a rising edge is generated in the control signal S_{CNT}, when the overcurrent protection signal S_{OCP} is received even without going through the on-time T_{ON}, the control logic 140 immediately switches the control signal S_{CNT} to a low level, and the switching transistor M1 is accordingly turned off. Thus, the switch current I_{SW} can be limited to be less than the protection current I_{OCP} by the switching control circuit 100 (however, it is possible that the switch current I_{SW} slightly exceeds the protection current I_{OCP} due to a control delay). The jitter control circuit 300_4 sets a current less than the protection current I_{OCP} to be the threshold current I_{TH4} by using the protection current I_{OCP} as a reference. For example, the jitter control circuit 300_4 can set the threshold current I_{TH4} to be k times the threshold current I_{TH4}. The coefficient k has a predetermined value (for example, 0.3 or 0.5) that satisfies “0<k<1”. The current detection circuit 341 can be a circuit shared by the overcurrent protection circuit 160 and the jitter control circuit 300_4. In this case, the overcurrent protection circuit 160 uses the current detecting circuit 341 to detect the switch current I_{SW} to be compared with the protection current I_{OCP}.

A setting terminal (not shown) for setting the threshold current I_{TH4} can be included in advance in the external terminals of the power supply control device 10, and the jitter control circuit 300_4 variably sets the threshold current I_{TH4} according to a voltage input to the setting terminal or according to a value of a setting resistor connected between the setting terminal and the ground GND1. Alternatively, the threshold current I_{TH4} can be variably set by the jitter control circuit 300_4 based on setting information supplied to the power supply control device 10 from an external circuit (not shown) of the power supply control device 10.

### Fifth Embodiment

The fifth embodiment is described below. To switch whether a jitter is to be added, it is possible that ripples in the output voltage V_{OUT} deteriorate drastically according to content of the jitter added. Considering the situations above, in the fifth embodiment, an amount of the jitter to be added is adjusted according to the output voltage V_{OUT}. The method shown in FIG. 5 is applicable to any one of the first to fourth embodiments. FIG. 24 shows a jitter adding circuit 200 and a jitter control circuit 300 of the fifth embodiment. An enable signal S_{EN} shown in the fifth embodiment refers to any one of the enable signals S_{EN1} to S_{EN4} of the first to fourth embodiments. When the fifth embodiment is combined with an i^{th} embodiment, the enable signal S_{EN} of the fifth embodiment refers to an enable signal S_{E}Ni (where i is 1, 2, 3 or 4 herein).

The jitter adding circuit 200 of the fifth embodiment is configured to be able to change an amount of a jitter added to the switching frequency f_{SW} in the jitter adding stable. The amount of the jitter refers to a value of a variable range of the switching frequency f_{SW} in the jitter adding state. As described with reference to FIG. 10, in the jitter adding state, the switching frequency f_{SW} varies within a range between a frequency (f_{O}+4·Δf) and a frequency (f_{O}-4·Δf), and so the amount of the jitter is represented by “8·Δf”. The jitter adding circuit 200 of the fifth embodiment is configured to be further able to change the step size Δf, and change the amount of the jitter by varying the step size Δf.

In the fifth embodiment, as shown in FIG. 24, in addition to supplying the enable signal S_{EN} to the jitter adding circuit 200, the jitter control circuit 300 further supplies a jitter amount specifying signal S_{JA} to the jitter adding circuit 200, accordingly variably setting the amount of the jitter. The amount of the jitter is specified by the jitter amount specifying signal S_{JA}. When “S_{EN}=1”, the jitter adding circuit 200 adds a jitter to the switching frequency f_{SW} according to the amount of the jitter in the specified content in the jitter amount specifying signal S_{JA}.

The jitter control circuit 300 of the fifth embodiment is provided with a current detecting circuit 351 and a jitter amount specifying circuit 352. The current detection circuit 351, the same as the current detection circuit 331 of the third embodiment or the current detection circuit 341 of the fourth embodiment (referring to FIG. 17 or FIG. 20), detects the switch current I_{SW}, and outputs a voltage V_{I} indicating a detection value of the switch current I_{SW}.

The jitter amount specifying circuit 352 specifies a peak (a maximum value) of the switch current I_{SW}, and generates the jitter amount specifying signal S_{JA} according to the peak of the switch current I_{SW}. At this point, the jitter amount specifying signal S_{JA} is generated in a manner that the amount of the jitter (the step size Δf herein) increases as the peak of the switch current I_{SW} increases.

More specifically, for example, the jitter control circuit 300 compares the switch current I_{SW} with each of threshold currents I_{TH5H} and I_{TH5L} during the on-period of the switching transistor M1. The threshold currents I_{TH5H} and I_{TH5L} have predetermined current values that satisfy “I_{OCP}>I_{TH5H}>I_{TH5L}>0”. In practice, a comparator that compares the voltage V₁ with a first threshold voltage corresponding to the threshold current I_{TH5H} and a comparator that compares the voltage V₁ with a second threshold voltage corresponding to the threshold current I_{TH5H} are provided in the jitter control circuit 300 in advance. Moreover, the jitter control circuit 300 sets the enable signal S_{EN} to a value of “1” by using a condition that the switch current I_{SW} reaches the threshold current I_{TH5L} within the on-period of the switching transistor M1. Herein, the threshold current I_{TH5L} is equivalent to the threshold current I_{TH4} of the fourth embodiment.

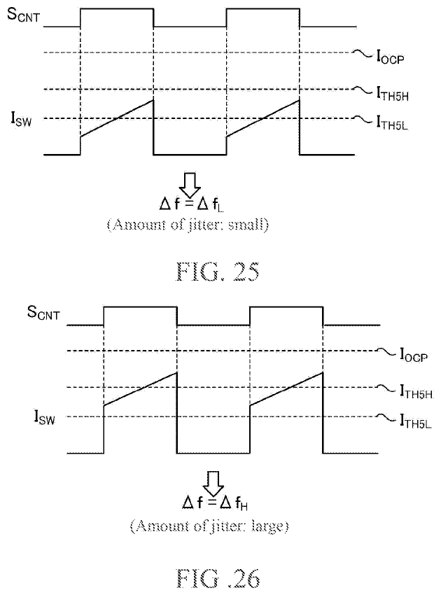

When the enable signal S_{EN} is set to a value of “1”, the jitter amount specifying circuit 352 determines whether the switch current I_{SW} has reached the threshold current I_{TH5H} within the on-period of the switching transistor M1. Moreover, as shown in FIG. 25, if the switch current I_{SW} has not yet reached the threshold current I_{TH5H}, the jitter amount specifying circuit 352 generates the jitter amount specifying signal S_{JA} to have the step size Δf become a predetermined amount Δf_{L}. As shown in FIG. 26, if the switch current I_{SW} has reached the threshold current I_{TH5H}, the jitter amount specifying circuit 352 generates the jitter amount specifying signal S_{JA} to have the step size Δf become a predetermined amount Δf_{H}. Herein, the predetermined amounts Δf_{L} and Δf_{H} are in amounts in a unit of frequency and satisfy “Δf_{H}>Δf_{L}>0. For example, the predetermined amount Δf_{H} is 5.0 kHz, and the predetermined amount Δf_{L} is 2.5 kHz. Accordingly, even if “S_{EN}=1”, the amount of the jitter is smaller when the output power PW_{OUT} is smaller, and the amount of the jitter is larger when the output power PW_{OUT} is larger. As a result, the amount of the jitter that can be added decreases around switching of whether jitter is to be added, and so drastic deterioration of ripples in the output voltage V_{OUT} can be suppressed.

The jitter control circuit 300 sets two currents less than the protection current I_{OCP} to be the threshold currents I_{TH5H} and I_{TH5L} by using the protection current I_{OCP} as a reference. For example, the jitter control circuit 300 can set the threshold currents I_{TH5H} and I_{TH5L} according to “I_{TH5H}=k_{H}×I_{OCP}” and “I_{TH5L}=k_{L}×I_{OCP}”. The coefficient k_{H} and k_{L} have predetermined values that satisfy “1>k_{H}>k_{L}>0”, and for example, (k_{H}, k_{L})=(0.5, 0.3). The current detection circuit 351 can be a circuit shared by the overcurrent protection circuit 160 and the jitter control circuit 300. In this case, the overcurrent protection circuit 160 uses the current detecting circuit 351 to detect the switch current I_{SW} to be compared with the protection current I_{OCP}.

A setting terminal (not shown) for setting the threshold currents I_{TH5H} and I_{TH5L} can also be included in advance in the external terminals of the power supply control device 10, and the jitter control circuit 300 variably sets the threshold currents I_{TH5H} and I_{TH5L} according to a voltage input to the setting terminal or according to a value of a setting resistor connected between the setting terminal and the ground GND1. Alternatively, the threshold currents I_{TH5H} and I_{TH5L} can be variably set by the jitter control circuit 300 based on setting information supplied to the power supply control device 10 from an external circuit (not shown) of the power supply control device 10.

A method of varying the amount of the jitter by varying the step size Δf is described; however, a variation method below can also be used. In the variation method, the step size Δf is fixed to be constant. The jitter adding circuit 200 of the variation method varies the switching frequency f_{SW} within a range between a frequency f_{O}+m·Δf) and a frequency (f_{O}-m·Δf), and varies by a unit of the step size Δf. As shown in FIG. 25, if the switch current I_{SW} has not yet reached a threshold current I_{TH5H}, the jitter amount specifying circuit 352 generates the jitter amount specifying signal S_{JA} to have “m=m_{L}”. As shown in FIG. 26, if the switch current I_{SW} has reached the threshold current I_{TH5H}, the jitter amount specifying circuit 352 generates the jitter amount specifying signal S_{JA} to have “m=m_{H}”. Herein, m_{H} and m_{L} are natural numbers that satisfy “m_{H}>mL”, for example, “(m_{H}, m_{L})=(4, 2)”.

Moreover, the amount of the jitter is variable set in two levels according to the peak of the switch current I_{SW}; however, the amount of the jitter can also be variable set in three levels according to the peak of the switch current I_{SW}.

### Variation Example

Variation techniques of the items and supplementary items are described.

For an arbitrary signal or voltage, the relationship between the high level and the low level thereof can be opposite to the relationships described, provided that the form of the subject is not compromised.

The types of the channels of the field-effect transistors (FETs) shown in the embodiments are examples. Without compromising the form of the subject, the channel type of any FET can be varied between P-type channels and N-type channels.

Given that no inappropriateness is incurred, an arbitrary transistor can also be any type of transistor. For example, given that no anomalies incurred, an arbitrary transistor implemented by a MOSFET can be replaced by a junction FET, an insulated gate bipolar transistor (IGBT) or a bipolar transistor. Any transistor includes a first electrode, a second electrode and a third electrode. In an FET, one between the first and second electrodes is the drain and the other is the source, and the control electrode is the gate. In an IGBT, one between the first and second electrodes is the collector and the other is the emitter, and the control electrode is the gate. For a bipolar transistor that is not an IGBT, one between the first and second electrodes is the collector and the other is the emitter, and the control electrode is the base.

Various modifications may be made to the embodiments of the present disclosure within the scope of the technical concept of the claims. The embodiments above are only examples of possible implementations of the present disclosure, and the meanings of the terms of the present disclosure or the constituting components are not limited to the meanings of the terms used in the embodiments above. The specific numerical values used in the description are only examples, and these numerical values may be modified to various other numerical values.

### Note

A note is attached to the present application to show specific configuration examples of the embodiments above.

A power supply control device of an aspect of the present disclosure is configured as (a first configuration) a power supply control device (10), used in an insulated DC/DC converter (1) that uses a transformer (TR) having a primary winding (W1) and a secondary winding (W2) to generate an output voltage (V_{OUT}) in a secondary circuit from an input voltage (V_{IN}) in a primary circuit, the power supply control device (10) comprising:
a switching element (M1), connected in series to the primary winding;
a switching control circuit (100), configured to transmit power from the primary circuit to the secondary circuit by switch driving the switching element in an operation mode of a continuous current mode or a discontinuous current mode;
a jitter adding circuit (200), configured to be able to add a jitter to a switching frequency of the switching element; and
a jitter control circuit (300), configured to control whether the jitter is added to the switching frequency through control of the jitter adding circuit, wherein
the jitter control circuit stops applying the jitter to the switching frequency in the discontinuous current mode.

Accordingly, the switching frequency can be suppressed from getting too unstable, and as a result, ripples in an output voltage can be reduced.

The power supply control device (referring to FIG. 12 to FIG. 14) of the first configuration can also be configured as (a second configuration), wherein
the switching frequency in the continuous current mode is equal to or greater than the switching frequency in the discontinuous current mode, and
the jitter control circuit (300_1) includes a frequency detecting circuit (310) configured to detect the switching frequency and control whether the jitter is applied to the switching frequency according to a detection result of the switching frequency.

The power supply control device of the second configuration can also be configured as (a third configuration), wherein the jitter control circuit is configured to
determine whether the operation mode is the continuous current mode or the discontinuous current mode according to the switching frequency detected by the frequency detection circuit,
add the jitter to the switching frequency when the operation mode is determined to be the continuous current mode, and
stop adding of the jitter to the switching frequency when the operation mode is determined to be the discontinuous current mode.

The power supply control device of the first configuration (referring to FIG. 15 and FIG. 16) can also be configured as (a fourth configuration), wherein the jitter control circuit (300_2) is configured to
determine whether the operation mode is the continuous current mode or the discontinuous current mode based on a voltage generated in the secondary winding,
add the jitter to the switching frequency when the operation mode is determined to be the continuous current mode, and
stop adding of the jitter to the switching frequency when the operation mode is determined to be the discontinuous current mode.

The power supply control device of the fourth configuration can also be configured as (a fifth configuration), wherein the jitter control circuit is configured to,
detect a specific transition in which a comparison voltage (V_{ZT}) changes from a state that the comparison voltage is equal to or greater than a threshold voltage (V_{THL}) to a state that the comparison voltage is less than the threshold voltage, by comparing a comparison voltage corresponding to the voltage generated in the secondary winding with a predetermined threshold voltage,
determine the operation mode to be the discontinuous current mode when the specific transition is detected multiple times within one cycle of switch driving of the switching element, and
determine the operation mode is the continuous current mode when the specific transition is not detected multiple times within the one cycle.

The power supply control device of the first configuration (referring to FIG. 17 and FIG. 19) can also be configured as (a sixth configuration), wherein the jitter control circuit (300_3) is configured to
determine whether the operation mode is the continuous current mode or the discontinuous current mode according to a switch current (I_{SW}) flowing through the switching element during an on-period of the switching element,
add the jitter to the switching frequency when the operation mode is determined to be the continuous current mode, and
stop adding of the jitter to the switching frequency when the operation mode is determined to be the discontinuous current mode.

The power supply control device of the sixth configuration can also be configured as (a seventh configuration), the jitter control circuit includes a circuit configured to determine a magnitude relationship between the switch current and a predetermined threshold current (I_{TH3}), and measures the time (T_{D3}) from when the switching element is turned on until the switch current reaches the threshold current, and the jitter control circuit is configured to
determine the operation mode to be the discontinuous current mode when a measured time is greater than a predetermined time (T_{TH3}), and
determine the operation mode is to be the continuous current mode when the measured time is less than the predetermined time.

The power supply control device of the first configuration (referring to FIG. 20 and FIG. 22) can also be configured as (an eighth configuration), wherein the jitter control circuit is configured to
determine whether a switch current (I_{SW}) flowing through the switching element reaches a predetermined threshold current (I_{TH4}) during an on-period of the switching element,
add the jitter to the switching frequency when the switch current reaches the threshold current, and
stop adding the jitter to the switching frequency when the switch current does not reach the threshold current,
wherein in the discontinuous current mode, a peak of the switch current is lower than the threshold current.

The power supply control device of the eighth configuration can also be configured as (a ninth configuration), wherein
in the continuous current mode, the switch current increases or decreases in conjunction with an increase or decrease in power consumption of a load receiving the output voltage,
the jitter control circuit is configured to add the jitter to the switching frequency when the switch current reaches the threshold current in the continuous current mode, and
even in the continuous current mode, when the switch current does not reach the threshold current, addition of the jitter to the switching frequency is stopped.

The power supply control device of the eighth or ninth configuration can also be configured as (a tenth configuration), wherein
the switching control circuit includes an overcurrent protection circuit (160) configured to limit the switch current to be less than a predetermined protection current (I_{OCP}), and
the jitter control circuit is configured to set the threshold current to a current less than the protection current according to the protection current.

The power supply control device of any one of the first to fifth configurations (referring to FIG. 24 to FIG. 26) can also be configured as (an eleventh configuration), wherein
the jitter adding circuit is configured to be able to change an amount of the jitter added to the switching frequency, and
the jitter control circuit is configured to variably set the amount of the jitter according to a switch current flowing through the switching element during an on-period of the switching element when the jitter is added to the switching frequency using the jitter adding circuit.

Accordingly, an appropriate amount of a jitter corresponding to the state of a load can be provided, and output voltage ripple deterioration can be suppressed by optimizing the amount of the jitter.

The power supply control device of any one of the sixth to tenth configurations (referring to FIG. 24 to FIG. 26) can also be configured as (a twelfth configuration), wherein
the jitter adding circuit is configured to be able to change an amount of the jitter added to the switching frequency, and
the jitter control circuit is configured to variably set the amount of the jitter according to the switch current when the jitter is added to the switching frequency using the jitter adding circuit.

Accordingly, an appropriate amount of a jitter corresponding to the state of a load can be provided, and output voltage ripple deterioration can be suppressed by optimizing the amount of the jitter.

The power supply control device of any one of the first to twelfth configurations can also be configured as (a thirteenth configuration), wherein
the switching control circuit includes a control voltage generating circuit (110) configured to generate a control voltage (V_{REFS}) based on a voltage difference between the input voltage and a switch voltage (V_{SW}) generated at a connection node between the switching element and the primary winding during an off-period of the switching element, and
the switching frequency is controlled in accordance with a control of on/off of the switching element based on the control voltage.

The power supply control device of the thirteenth configuration can also be configured as (a fourteenth configuration), wherein
the switching control circuit includes a slope voltage generating circuit (120) configured to generate a slope voltage (V_{SLP}) monotonically increasing from a predetermined potential during the off-period of the switching element,
the switching control circuit is configured to
determine a turn-on timing of the switching element by comparing the control voltage with the slope voltage, and
set a predetermined constant on-time as an on-time (T_{ON}) of the switching element in each cycle of switch driving of the switching element, and
the jitter adding circuit is configured to add the jitter to the switching frequency by varying the slope voltage during the off-period of the switching element. Moreover, in the configuration in FIG. 3, the predetermined potential at a starting point of an increase in the slope voltage is a ground potential GND1, but can also be a potential other than the ground potential GND1.

1. A power supply control device, used in an insulated DC/DC converter that uses a transformer having a primary winding and a secondary winding to generate an output voltage in a secondary circuit from an input voltage in a primary circuit, comprising:
a switching element, connected in series to the primary winding;
a switching control circuit, configured to transmit power from the primary circuit to the secondary circuit by switch driving the switching element in an operation mode of a continuous current mode or a discontinuous current mode;
a jitter adding circuit, configured to be able to add a jitter to a switching frequency of the switching element; and
a jitter control circuit, configured to control whether the jitter is added to the switching frequency through control of the jitter adding circuit, wherein
the jitter control circuit stops applying the jitter to the switching frequency in the discontinuous current mode.

2. The power supply control device of claim 1, wherein
the switching frequency in the continuous current mode is equal to or greater than the switching frequency in the discontinuous current mode, and
the jitter control circuit includes a frequency detecting circuit configured to detect the switching frequency and control whether the jitter is applied to the switching frequency based on a detection result of the switching frequency.

3. The power supply control device of claim 2, wherein the jitter control circuit is configured to
determine whether the operation mode is the continuous current mode or the discontinuous current mode based on the switching frequency detected by the frequency detection circuit,
add the jitter to the switching frequency when the operation mode is determined to be the continuous current mode, and
stop adding of the jitter to the switching frequency when the operation mode is determined to be the discontinuous current mode.

4. The power supply control device of claim 1, wherein the jitter control circuit is configured to
determine whether the operation mode is the continuous current mode or the discontinuous current mode based on a voltage generated in the secondary winding,
add the jitter to the switching frequency when the operation mode is determined to be the continuous current mode, and
stop adding of the jitter to the switching frequency when the operation mode is determined to be the discontinuous current mode.

5. The power supply control device of claim 4, wherein
the jitter control circuit is configured to,
detect a specific transition in which a comparison voltage changes from a state that the comparison voltage is equal to or greater than a threshold voltage to a state that the comparison voltage is less than the threshold voltage, by comparing a comparison voltage corresponding to the voltage generated in the secondary winding with a predetermined threshold voltage,
determine the operation mode to be the discontinuous current mode when the specific transition is detected multiple times within one cycle of switch driving of the switching element, and
determine the operation mode is the continuous current mode when the specific transition is not detected multiple times within the one cycle.

6. The power supply control device of claim 1, wherein the jitter control circuit is configured to
determine whether the operation mode is the continuous current mode or the discontinuous current mode based on a switch current flowing through the switching element during an on-period of the switching element,
add the jitter to the switching frequency when the operation mode is determined to be the continuous current mode, and
stop adding of the jitter to the switching frequency when the operation mode is determined to be the discontinuous current mode.

7. The power supply control device of claim 6, wherein
the jitter control circuit includes a circuit configured to determine a magnitude relationship between the switch current and a predetermined threshold current, and measures the time from when the switching element is turned on until the switch current reaches the threshold current,
the jitter control circuit is configured to
measure a time from when the switching element is turned on until the switch current reaches the threshold current,
determine the operation mode to be the discontinuous current mode when a measured time is greater than a predetermined time, and
determine the operation mode is to be the continuous current mode when the measured time is less than the predetermined time.

8. The power supply control device of claim 1, wherein the jitter control circuit is configured to
determine whether a switch current flowing through the switching element reaches a predetermined threshold current during an on-period of the switching element,
add the jitter to the switching frequency when the switch current reaches the threshold current, and
stop adding the jitter to the switching frequency when the switch current does not reach the threshold current,
wherein in the discontinuous current mode, a peak of the switch current is lower than the threshold current.

9. The power supply control device of claim 8, wherein
in the continuous current mode, the switch current increases or decreases in conjunction with an increase or decrease in power consumption of a load receiving the output voltage,
the jitter control circuit is configured to add the jitter to the switching frequency when the switch current reaches the threshold current in the continuous current mode, and
even in the continuous current mode, when the switch current does not reach the threshold current, addition of the jitter to the switching frequency is stopped.

10. The power supply control device of claim 8, wherein
the switching control circuit includes an overcurrent protection circuit configured to limit the switch current to be less than a predetermined protection current, and
the jitter control circuit is configured to set the threshold current to a current less than the protection current according to the protection current.

11. The power supply control device of claim 1, wherein
the jitter adding circuit is configured to be able to change an amount of the jitter added to the switching frequency, and
the jitter control circuit is configured to variably set the amount of the jitter according to a switch current flowing through the switching element during an on-period of the switching element when the jitter is added to the switching frequency using the jitter adding circuit.

12. The power supply control device of claim 2, wherein
the jitter adding circuit is configured to be able to change an amount of the jitter added to the switching frequency, and
the jitter control circuit is configured to variably set the amount of the jitter according to a switch current flowing through the switching element during an on-period of the switching element when the jitter is added to the switching frequency using the jitter adding circuit.

13. The power supply control device of claim 4, wherein
the jitter adding circuit is configured to be able to change an amount of the jitter added to the switching frequency, and
the jitter control circuit is configured to variably set the amount of the jitter according to a switch current flowing through the switching element during an on-period of the switching element when the jitter is added to the switching frequency using the jitter adding circuit.

14. The power supply control device of claim 6, wherein
the jitter adding circuit is configured to be able to change an amount of the jitter added to the switching frequency, and
the jitter control circuit is configured to variably set the amount of the jitter according to the switch current when the jitter is added to the switching frequency using the jitter adding circuit.

15. The power supply control device of claim 7, wherein
the jitter adding circuit is configured to be able to change an amount of the jitter added to the switching frequency, and
the jitter control circuit is configured to variably set the amount of the jitter according to the switch current when the jitter is added to the switching frequency using the jitter adding circuit.

16. The power supply control device of claim 8, wherein
the jitter adding circuit is configured to be able to change an amount of the jitter added to the switching frequency, and
the jitter control circuit is configured to variably set the amount of the jitter according to the switch current when the jitter is added to the switching frequency using the jitter adding circuit.

17. The power supply control device of claim 1, wherein
the switching control circuit includes a control voltage generating circuit configured to generate a control voltage based on a voltage difference between the input voltage and a switch voltage generated at a connection node between the switching element and the primary winding during an off-period of the switching element, and
the switching frequency is controlled in accordance with a control of on/off of the switching element based on the control voltage.

18. The power supply control device of claim 2, wherein
the switching control circuit includes a control voltage generating circuit configured to generate a control voltage based on a voltage difference between the input voltage and a switch voltage generated at a connection node between the switching element and the primary winding during an off-period of the switching element, and
the switching frequency is controlled in accordance with a control of on/off of the switching element based on the control voltage.

19. The power supply control device of claim 4, wherein
the switching control circuit includes a control voltage generating circuit configured to generate a control voltage based on a voltage difference between the input voltage and a switch voltage generated at a connection node between the switching element and the primary winding during an off-period of the switching element, and
the switching frequency is controlled in accordance with a control of on/off of the switching element based on the control voltage.

20. The power supply control device of claim 17, wherein
the switching control circuit includes a slope voltage generating circuit configured to generate a slope voltage monotonically increasing from a predetermined potential during the off-period of the switching element,
the switching control circuit is configured to
determine a turn-on timing of the switching element by comparing the control voltage with the slope voltage, and
set a predetermined constant on-time as an on-time of the switching element in each cycle of switch driving of the switching element, and
the jitter adding circuit is configured to add the jitter to the switching frequency by varying the slope voltage during the off-period of the switching element.
